(19) United States
(12) Patent Application Publication
(10) Pub. No.: US 2025/0275006 A1
(43) Pub. Date: Aug. 28, 2025

(54) INFORMATION TRANSMISSION METHOD AND APPARATUS, AND STORAGE MEDIUM

(71) Applicant: Beijing Xiaomi Mobile Software Co., Ltd., Beijing (CN)

(72) Inventors: Wei HONG, Beijing (CN); Fang LI, Beijing (CN)

(73) Assignee: Beijing Xiaomi Mobile Software Co., Ltd., Beijing (CN)

(21) Appl. No.: 18/858,070

(22) PCT Filed: Apr. 19, 2022
(86) PCT No.: PCT/CN2022/087753

§ 371 Date: Oct. 18, 2024

(51) Int. Cl. H04W 76/20; H04W 8/22; H04W 76/19; H04W 84/06

(52) U.S. Cl. CPC H04W 76/20; H04W 8/22; H04W 76/19; H04W 84/06

(57) ABSTRACT

A method apparatus, and a storage medium, for information transmission in a wireless communication system. The information transmission is performed by: sending notification information to a base station upon completion of a target operation, where the target operation is an operation associated with a radio resource control (RRC) connection between the unmanned aerial vehicle and the base station, and the notification information informs the base station that the unmanned aerial vehicle stores flight path information.

### CROSS-REFERENCE TO RELATED APPLICATION

The present application is a U.S. National Stage of International Application No. PCT/CN2022/087753, filed on Apr. 19, 2022, the contents of which are incorporated herein by reference in their entirety.

### TECHNICAL FIELD

The present disclosure relates to the field of communications, and in particular, to an information transmission method and apparatus, and a storage medium.

### BACKGROUND

An unmanned aerial vehicle (UAV) is an unmanned aerial vehicle that is manipulated by using a radio remote control device and a self-contained program control apparatus. An unmanned aerial vehicle is actually a general term for unmanned aerial vehicles, and may be defined from a technical perspective as: an unmanned fixed-wing aircraft, an unmanned vertical take-off and landing aircraft, an unmanned airship, an unmanned helicopter, an unmanned multi-rotor aircraft, an unmanned umbrella wing aircraft, and the like.

With the rapid development of unmanned aerial vehicle technology, the reduction of cost, and the improvement of function, unmanned aerial vehicles are increasingly being applied to ordinary consumers. The application of unmanned aerial vehicles to industry is the true need for unmanned aerial vehicles. At present, in the fields of aerial photography, agriculture, plant protection, miniature selfie, express transportation, disaster rescue, observation of wild animals, monitoring infectious diseases, surveying and mapping, news reporting, electric power inspection, disaster relief, film and television shooting, creating romance, and the like, the application of the unmanned aerial vehicle itself is greatly expanded, and all countries are actively expanding industry application and developing unmanned aerial vehicle technologies.

In order to expand the application range of unmanned aerial vehicles further, the 3rd Generation Partnership Project (3GPP) approved the Enhanced Support for Aerial Vehicles project. It is intended to study and standardize how to make cellular networks provide services that meet the needs of unmanned aerial vehicles.

Unmanned aerial vehicles typically have two flight modes. One is a fixed mode, that is, an operator plans a flight route of the unmanned aerial vehicle on a controller, so that the unmanned aerial vehicle can fly according to the planned route, and the controller does not need to control the unmanned aerial vehicle regularly. The other mode is a dynamic mode, that is, the controller may remotely control the unmanned aerial vehicle in real time through the controller. For the fixed mode, since the flight route and trajectory of the UAV are fixed, the cellular network may pre-judge which cellular network base stations the UAV will pass through.

Therefore, how to efficiently report flight path information by the unmanned aerial vehicle is an urgent problem to be resolved. Furthermore, once the UAV changes its flight mode, for example, from dynamic mode to fixed mode, how to report the flight path information efficiently when the UAV changes its flight mode is also an urgent problem to be solved.

### SUMMARY

In order to overcome the problems existing in the related art, embodiments of the present disclosure provide information transmission methods and apparatuses, and storage media.

According to a first aspect of an embodiment of present disclosure, an information transmission method is provided, which is performed by an unmanned aerial vehicle, and the method includes:
sending notification information to a base station upon completion of a target operation, where the target operation is an operation associated with a radio resource control (RRC) connection between the unmanned aerial vehicle and the base station, and the notification information informs the base station that the unmanned aerial vehicle stores flight path information.

In some examples, the completion of a target operation includes any one of:
completion of an RRC connection setup operation;
completion of an RRC connection reestablishment operation;
completion of an RRC restart operation; and
completion of an RRC reconfiguration operation.

In some examples, the sending notification information to a base station includes:
sending the notification information to the base station through first RRC signaling, where the first RRC signaling corresponds to the target operation.

In some examples, the first RRC signaling includes any one of:
RRC Setup Complete (RRCSetupComplete) signaling;
RRC Reestablishment Complete (RRCReestablishmentComplete) signaling;
RRC Resume Complete (RRCResumeComplete) signaling; and
RRC Reconfiguration Complete (RRCReconfigurationComplete) signaling.

In some examples, the first RRC signaling includes any one of:
RRC Connection Setup Complete (RRCConnectionSetupComplete) signaling;
RRC Connection Reestablishment Complete (RRCConnectionReestablishmentComplete) signaling;
RRC Connection Resume Complete (RRCConnectionResumeComplete) signaling; and
RRC Connection Reconfiguration Complete (RRCConnectionReconfigurationComplete) signaling.

In some examples, the method further includes:
receiving first indication information sent by the base station based on the notification information, where the first indication information instructs the unmanned aerial vehicle to report flight path information; and
reporting the flight path information to the base station based on the first indication information.

In some examples, the receiving first indication information sent by the base station based on the notification information includes:
receiving the first indication information sent by the base station through second RRC signaling based on the notification information;
where the reporting the flight path information to the base station includes:
reporting the flight path information to the base station through third RRC signaling.

In some examples, the second RRC signaling is user equipment information request (UEInformationRequest) signaling, and the third RRC signaling is user equipment information response (UEInformationResponse) signaling.

In some examples, the method further includes:
reporting capability information to the base station upon the completion of the target operation, where the capability information indicates whether the unmanned aerial vehicle has a capability to report flight path information.

In some examples, the reporting capability information to the base station includes:
reporting the capability information to the base station through fourth RRC signaling.

In some examples, reporting the capability information to the base station through fourth RRC includes:
reporting the capability information to the base station through a first information element in the fourth RRC signaling.

In some examples, the fourth RRC signaling is user equipment-evolved universal terrestrial radio access-capability (UE-EUTRA-Capability) signaling, and the first information element is an OtherParameters information element; or
the fourth RRC signaling is user equipment-new radio-capability (UE-NR-Capability) signaling, and the first information element is an OtherParameters information element.

In some examples, the method further includes:
receiving configuration information sent by the base station based on the capability information, where the configuration information is for configuring the unmanned aerial vehicle to report flight path information.

In some examples, the configuration information is for configuring at least one of:
whether the unmanned aerial vehicle is allowed to report flight path information; or
whether the unmanned aerial vehicle is allowed to report second indication information;
where the second indication information indicates that the unmanned aerial vehicle stores flight path information.

In some examples, the receiving configuration information sent by the base station based on the capability information includes:
receiving the configuration information sent by the base station through fifth RRC signaling based on the capability information.

In some examples, the receiving the configuration information sent by the base station through fifth RRC signaling based on the capability information includes:
receiving the configuration information sent by the base station through a second information element in the fifth RRC signaling based on the capability information.

In some examples, the fifth RRC signaling is RRC Connection Reconfiguration (RRCConnectionReconfiguration) signaling, and the second information element is an other configuration (OtherConfig) information element; or
the fifth RRC signaling is RRC Reconfiguration (RRCReconfiguration) signaling, and the second information element is an other configuration (OtherConfig) information element.

In some examples, the method further includes:
in response to determining that a flight mode of the unmanned aerial vehicle changes, obtaining changed flight path information; and
reporting, based on the configuration information, the changed flight path information to the base station.

In some examples, the reporting, based on the configuration information, the changed flight path information to the base station includes:
in response to determining that the configuration information indicates that the unmanned aerial vehicle is allowed to report flight path information, reporting the changed flight path information to the base station through sixth RRC signaling.

In some examples, the reporting, based on the configuration information, the changed flight path information to the base station includes:
in response to determining that the configuration information indicates that the unmanned aerial vehicle is allowed to report the second indication information, reporting the second indication information to the base station through sixth RRC signaling;
receiving first indication information sent by the base station based on the second indication information, where the first indication information instructs the unmanned aerial vehicle to report flight path information; and
reporting, based on the first indication information, the changed flight path information to the base station.

In some examples, the sixth RRC signaling is user equipment assistance information (UEAssistanceInformation) signaling.

In some examples, the receiving first indication information sent by the base station based on the second indication information includes:
receiving the first indication information sent by the base station through seventh RRC signaling based on the second indication information;
where the reporting the changed flight path information to the base station includes:
reporting the changed flight path information to the base station through eighth RRC signaling.

In some examples, the seventh RRC signaling is user equipment information request (UEInformationRequest) signaling, and the eighth RRC signaling is user equipment information response (UEInformationResponse) signaling.

According to a second aspect of an embodiment of present disclosure, an information transmission method is provided, which is performed by a base station, and the method includes:
receiving notification information sent to the base station by an unmanned aerial vehicle upon completion of a target operation, where the target operation is an operation associated with a radio resource control (RRC) connection between the unmanned aerial vehicle and the base station, and the notification information informs the base station that the unmanned aerial vehicle stores flight path information.

In some examples, the completion of a target operation includes any one of:
completion of g an RRC connection setup operation;
completion of an RRC connection reestablishment operation;
completion of an RRC restart operation; and
completion of an RRC reconfiguration operation.

In some examples, the receiving notification information sent to the base station by an unmanned aerial vehicle upon completion of a target operation includes:
receiving the notification information sent to the base station by the unmanned aerial vehicle through first RRC signaling upon completion of the target operation, where the first RRC signaling corresponds to the target operation.

In some examples, the first RRC signaling includes any one of:
RRC Setup Complete (RRCSetupComplete) signaling;
RRC Reestablishment Complete (RRCReestablishmentComplete) signaling;
RRC Resume Complete (RRCResumeComplete) signaling; and
RRC Reconfiguration Complete (RRCReconfigurationComplete) signaling.

In some examples, the first RRC signaling includes any one of:
RRC Connection Setup Complete (RRCConnectionSetupComplete) signaling;
RRC Connection Reestablishment Complete (RRCConnectionReestablishmentComplete) signaling;
RRC Connection Resume Complete (RRCConnectionResumeComplete) signaling; and
RRC Connection Reconfiguration Complete (RRCConnectionReconfigurationComplete) signaling.

In some examples, the method further includes:
sending, based on the notification information, first indication information to the unmanned aerial vehicle, where the first indication information instructs the unmanned aerial vehicle to report flight path information; and
receiving the flight path information reported to the base station by the unmanned aerial vehicle based on the first indication information.

In some examples, the sending first indication information to the unmanned aerial vehicle includes:
sending the first indication information to the unmanned aerial vehicle through second RRC signaling;
where the receiving the flight path information reported to the base station by the unmanned aerial vehicle based on the first indication information includes:
receiving the flight path information reported to the base station by the unmanned aerial vehicle through third RRC signaling based on the first indication information.

In some examples, the second RRC signaling is user equipment information request (UEInformationRequest) signaling, and the third RRC signaling is user equipment information response (UEInformationResponse) signaling.

In some examples, the method further includes:
receiving capability information reported to the base station by the unmanned aerial vehicle upon the completion of the target operation, where the capability information indicates whether the unmanned aerial vehicle has a capability to report flight path information.

In some examples, the receiving capability information reported to the base station by the unmanned aerial vehicle upon the completion of the target operation includes:
receiving the capability information reported to the base station by the unmanned aerial vehicle through fourth RRC signaling upon the completion of the target operation.

In some examples, the receiving the capability information reported to the base station by the unmanned aerial vehicle through fourth RRC signaling upon the completion of the target operation includes:
receiving the capability information reported to the base station by the unmanned aerial vehicle through a first information element in the fourth RRC signaling upon the completion of the target operation.

In some examples, the fourth RRC signaling is user equipment-evolved universal terrestrial radio access-capability (UE-EUTRA-Capability) signaling, and the first information element is an OtherParameters information element; or
the fourth RRC signaling is user equipment-new radio-capability (UE-NR-Capability) signaling, and the first information element is an OtherParameters information element.

In some examples, the method further includes:
in response to determining that the capability information indicates that the unmanned aerial vehicle has the capability to report the flight path information, sending configuration information to the unmanned aerial vehicle, where the configuration information is for configuring the unmanned aerial vehicle to report flight path information.

In some examples, the configuration information is for configuring at least one of:
whether the unmanned aerial vehicle is allowed to report flight path information;
whether the unmanned aerial vehicle is allowed to report second indication information;
where the second indication information indicates that the unmanned aerial vehicle stores flight path information.

In some examples, the sending configuration information to the unmanned aerial vehicle includes:
sending the configuration information to the unmanned aerial vehicle through fifth RRC signaling.

In some examples, the sending the configuration information to the unmanned aerial vehicle through fifth RRC signaling includes:
sending the configuration information to the unmanned aerial vehicle through a second information element in the fifth RRC signaling.

In some examples, the fifth RRC signaling is RRC Connection Reconfiguration (RRCConnectionReconfiguration) signaling, and the second information element is an other configuration (OtherConfig) information element; or
the fifth RRC signaling is RRC Reconfiguration (RRCReconfiguration) signaling, and the second information element is an other configuration (OtherConfig) information element.

In some examples, the method further includes:
receiving changed flight path information reported to the base station by the unmanned aerial vehicle based on the configuration information after the unmanned aerial vehicle determines that a flight mode changes.

In some examples, the receiving changed flight path information reported to the base station by the unmanned aerial vehicle based on the configuration information after the unmanned aerial vehicle determines that a flight mode changes includes:
when the configuration information indicates that the unmanned aerial vehicle is allowed to report flight path information, receiving the changed flight path information reported to the base station by the unmanned aerial vehicle through sixth RRC signaling after the unmanned aerial vehicle determines that the flight mode changes.

In some examples, the receiving changed flight path information reported to the base station by the unmanned aerial vehicle based on the configuration information after the unmanned aerial vehicle determines that a flight mode changes includes:
when the configuration information indicates that the unmanned aerial vehicle is allowed to report the second indication information, receiving the second indication information reported to the base station by the unmanned aerial vehicle through sixth RRC signaling after the unmanned aerial vehicle determines that the flight mode changes;
sending, based on the second indication information, first indication information to the unmanned aerial vehicle, where the first indication information instructs the unmanned aerial vehicle to report flight path information; and
receiving the changed flight path information reported to the base station by the unmanned aerial vehicle based on the first indication information.

In some examples, the sixth RRC signaling is user equipment assistance information (UEAssistanceInformation) signaling.

In some examples, the sending first indication information to the unmanned aerial vehicle includes:
sending the first indication information to the unmanned aerial vehicle through seventh RRC signaling;
where the receiving the changed flight path information reported to the base station by the unmanned aerial vehicle based on the first indication includes:
receiving the changed flight path information reported to the base station by the unmanned aerial vehicle through eighth RRC signaling based on the first indication information.

In some examples, the seventh RRC signaling is user equipment information request (UEInformationRequest) signaling, and the eighth RRC signaling is user equipment information response (UEInformationResponse) signaling.

According to a third aspect of an embodiment of present disclosure, an information transmission apparatus is provided, which is applied to an unmanned aerial vehicle, including:
a sending module, configured to send notification information to a base station upon completion of a target operation, where the target operation is an operation associated with a radio resource control (RRC) connection between the unmanned aerial vehicle and the base station, and the notification information informs the base station that the unmanned aerial vehicle stores flight path information.

According to a fourth aspect of an embodiment of present disclosure, an information transmission apparatus is provided, which is applied to a base station, including:
a receiving module, configured to receive notification information sent to the base station by an unmanned aerial vehicle upon completion of a target operation, where the target operation is an operation associated with a radio resource control (RRC) connection between the unmanned aerial vehicle and the base station, and the notification information informs the base station that the unmanned aerial vehicle stores flight path information.

According to a fifth aspect of an embodiment of the present disclosure, a computer-readable storage medium is provided, where the storage medium stores a computer program for executing any one of the information transmission methods on the unmanned aerial vehicle side.

According to a sixth aspect of an embodiment of the present disclosure, a computer-readable storage medium is provided, where the storage medium stores a computer program for executing any one of the information transmission methods on the base station side.

According to a seventh aspect of an embodiment of the present disclosure, an information transmission apparatus is provided, including:
a processor; and
a memory, configured to store processor-executable instructions;
where the processor is configured to execute any of the information transmission methods described above on the unmanned aerial vehicle side.

According to an eighth aspect of an embodiment of the present disclosure, an information transmission apparatus is provided, including:
a processor; and
a memory, configured to store processor-executable instructions;
where the processor is configured to execute any of the information transmission methods described above on the base station side.

The technical solutions provided by the embodiments of the present disclosure can include the following beneficial effects:

In the embodiments of the present disclosure, the UAV can send notification information to the base station upon completion of the target operation, where the target operation is an operation associated with the RRC connection between the unmanned aerial vehicle and the base station, and the notification information informs the base station that the unmanned aerial vehicle stores flight path information. So that the base station can determine that the unmanned aerial vehicle stores flight path information based on the notification information, and then obtain complete flight path information of the UAV subsequently, which improves the efficiency of reporting the flight path information of the UAV, and is simple to implement and high in usability.

It should be understood that the above general description and the following detailed descriptions are exemplary and explanatory only and do not limit the present disclosure.

### BRIEF DESCRIPTION OF DRAWINGS

The accompanying drawings, which are incorporated in and constitute a part of the specification, illustrate embodiments consistent with the present disclosure, and are used together with the specification to explain the principles of the present disclosure.

FIG. 1 is a flowchart of an information transmission method according to an embodiment of the present disclosure.

FIG. 2 is a flowchart of another information transmission method according to an embodiment of the present disclosure.

FIG. 3 is a flowchart of another information transmission method according to an embodiment of the present disclosure.

FIG. 4 is a flowchart of another information transmission method according to an embodiment of the present disclosure.

FIG. 5 is a flowchart of another information transmission method according to an embodiment of the present disclosure.

FIG. 6 is a flowchart of another information transmission method according to an embodiment of the present disclosure.

FIG. 7 is a flowchart of another information transmission method according to an embodiment of the present disclosure.

FIG. 8 is a flowchart of another information transmission method according to an embodiment of the present disclosure.

FIG. 9A is a flowchart of another information transmission method according to an embodiment of the present disclosure.

FIG. 9B is a flowchart of another information transmission method according to an embodiment of the present disclosure.

FIG. 10A is a flowchart of another information transmission method according to an embodiment of the present disclosure.

FIG. 10B is a flowchart of another information transmission method according to an embodiment of the present disclosure.

FIG. 11A is a flowchart of another information transmission method according to an embodiment of the present disclosure.

FIG. 11B is a flowchart of another information transmission method according to an embodiment of the present disclosure.

FIG. 12 is a flowchart of another information transmission method according to an embodiment of the present disclosure.

FIG. 13 is a flowchart of another information transmission method according to an embodiment of the present disclosure.

FIG. 14 is a flowchart of another information transmission method according to an embodiment of the present disclosure.

FIG. 15 is a flowchart of another information transmission method according to an embodiment of the present disclosure.

FIG. 16 is a flowchart of another information transmission method according to an embodiment of the present disclosure.

FIG. 17 is a flowchart of another information transmission method according to an embodiment of the present disclosure.

FIG. 18 is a flowchart of another information transmission method according to an embodiment of the present disclosure.

FIG. 19 is a flowchart of another information transmission method according to an embodiment of the present disclosure.

FIG. 20 is a flowchart of another information transmission method according to an embodiment of the present disclosure.

FIG. 21 is a flowchart of another information transmission method according to an embodiment of the present disclosure.

FIG. 22 is a flowchart of another information transmission method according to an embodiment of the present disclosure.

FIG. 23 is a flowchart of another information transmission method according to an embodiment of the present disclosure.

FIG. 24 is a flowchart of another information transmission method according to an embodiment of the present disclosure.

FIG. 25 is a block diagram of an information transmission apparatus according to an embodiment of the present disclosure.

FIG. 26 is a block diagram of another information transmission apparatus according to an embodiment of the present disclosure.

FIG. 27 is a structural schematic diagram of an information transmission apparatus according to an embodiment of the present disclosure of the present disclosure.

FIG. 28 is a structural schematic diagram of another information transmission apparatus according to an embodiment of the present disclosure of the present disclosure.

### DETAILED DESCRIPTION

Reference will now be made in detail to embodiments, examples of which are illustrated in the accompanying drawings. When the following description refers to the accompanying drawings, unless otherwise indicated, the same numbers in different accompanying drawings indicate the same or similar elements. Implementations described in the following embodiments do not represent all implementations consistent with the present disclosure. Rather, they are merely examples of apparatuses and methods consistent with some aspects of the present disclosure as detailed in the appended claims.

Terms used in the present disclosure are only for a purpose of describing specific embodiments, and are not limiting the present disclosure. Singular forms of “a,” said,” and “the” used in the present disclosure and in the claims are also intended to include majority forms, unless the context clearly indicates otherwise. It should also be understood that the term “and/or” as used herein refers to any or all of the possible combinations containing at least one of the listed items in association.

It should be understood that although terms first, second, third, etc. may be used to describe various information in the present disclosure, these information should not be limited to these terms. These terms are used only to distinguish the same type of information from one another. For example, without departing from the scope of the present disclosure, first information can also be called second information, and similarly, the second information can also be called the first information. Depending on the context, the word “if” as used herein can be interpreted as “at” or “when” or “in response to determining”.

Next, the information transmission method provided by the present disclosure will be introduced from an unmanned aerial vehicle side.

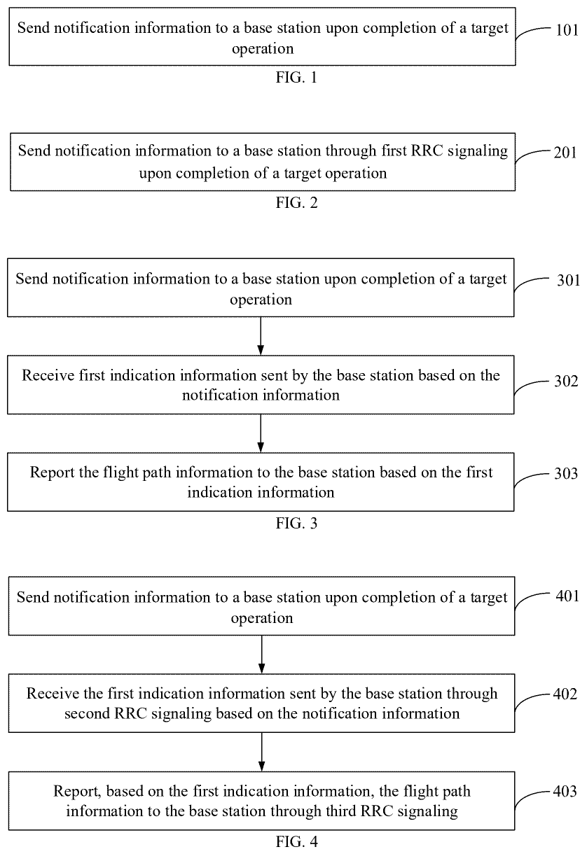

An embodiment of the present disclosure provides an information transmission method, referring to FIG. 1, FIG. 1 is a flowchart of an information transmission method according to an embodiment, which can be performed by an unmanned aerial vehicle, and the method may include the following step.

At step 101, notification information is sent to a base station upon completion of a target operation.

In the embodiment of the present disclosure, the target operation is an operation associated with a radio resource control (RRC) connection between the unmanned aerial vehicle and the base station, and the notification information informs the base station that the unmanned aerial vehicle stores flight path information. The flight path information may be flight path information of the unmanned aerial vehicle in a fixed mode or flight path information of the unmanned aerial vehicle in a dynamic mode, which is not limited by the present disclosure.

In a possible implementation, the completion of a target operation includes any one of: completion of an RRC connection setup operation; completion of an RRC connection reestablishment operation; completion of an RRC restart operation; and completion of an RRC reconfiguration operation.

In the above embodiment, the UAV can send notification information to the base station upon completion of a target operation, where the target operation is an operation associated with the RRC connection between the unmanned aerial vehicle and the base station, and the notification information informs the base station that the unmanned aerial vehicle stores flight path information. So that the base station can determine that the unmanned aerial vehicle stores flight path information based on the notification information, and then obtain complete flight path information of the UAV subsequently, which improves the efficiency of reporting the flight path information of the UAV, and is simple to implement and high in usability.

In some embodiments, with reference to FIG. 2, FIG. 2 is a flowchart of an information transmission method according to an embodiment, which can be performed by an unmanned aerial vehicle, and the method may include the following step.

At step 201, notification information is sent to a base station through first RRC signaling upon completion of a target operation.

In the embodiment of the present disclosure, the target operation is an operation associated with an RRC connection between the unmanned aerial vehicle and the base station, and the notification information informs the base station that the unmanned aerial vehicle stores flight path information. The flight path information may be flight path information of the unmanned aerial vehicle in a fixed mode or flight path information of the unmanned aerial vehicle in a dynamic mode, which is not limited by the present disclosure.

In a possible implementation, the completion of a target operation includes any one of: completion of an RRC connection setup operation; completion of an RRC connection reestablishment operation; completion of an RRC restart operation; and completion of an RRC reconfiguration operation.

In the embodiment of the present disclosure, the first RRC signaling can reuse existing RRC signaling in a protocol. It can also be newly defined RRC signaling in the protocol, which is not limited by the present disclosure.

In a possible implementation, when the first RRC signaling reuses the existing RRC signaling in the protocol, in the case of a new Radio (NR) network, the first RRC signaling can be any of the following: RRC Setup Complete (RRCSetupComplete) signaling; RRC Reestablishment Complete (RRCReestablishmentComplete) signaling; RRC Resume Complete (RRCResumeComplete) signaling; and RRC Reconfiguration Complete (RRCReconfigurationComplete) signaling.

Specifically, the first RRC signaling corresponds to the target operation. Upon completion of an RRC connection setup operation, the unmanned aerial vehicle can send the notification information to the base station through RRCSetupComplete signaling.

Upon completion of an RRC connection reestablishment operation, the unmanned aerial vehicle can send the notification information to the base station through RRCReestablishmentComplete signaling.

Upon completion of an RRC resume operation, the unmanned aerial vehicle can send the notification information to the base station through RRCResumeComplete signaling.

Upon completion of an RRC reconfiguration operation, the unmanned aerial vehicle can send the notification information to the base station through RRCReconfigurationComplete signaling.

In another possible implementation, in the case of a long term evolution (LTE) network, the first RRC signaling can be any of the following: RRC Connection Setup Complete (RRCConnectionSetupComplete) signaling; RRC Connection Reestablishment Complete (RRCConnectionReestablishmentComplete) signaling; RRC Connection Resume Complete (RRCConnectionResumeComplete) signaling; and RRC Connection Reconfiguration Complete (RRCConnectionReconfigurationComplete) signaling.

Specifically, the first RRC signaling corresponds to the target operation. Upon completion of an RRC connection setup operation, the unmanned aerial vehicle can send the notification information to the base station through RRCConnectionSetupComplete signaling.

Upon completion of an RRC connection reestablishment operation, the unmanned aerial vehicle can send the notification information to the base station through RRCConnectionReestablishmentComplete signaling.

Upon completion of an RRC resume operation, the unmanned aerial vehicle can send the notification information to the base station through RRCConnectionResumeComplete signaling.

Upon completion of an RRC reconfiguration operation, the unmanned aerial vehicle can send the notification information to the base station through RRCConnectionReconfigurationComplete signaling.

In the above embodiment, the UAV can send notification information to the base station through the first RRC signaling upon completion of the target operation, where the target operation is an operation associated with the RRC connection between the unmanned aerial vehicle and the base station, and the notification information informs the base station that the unmanned aerial vehicle stores flight path information. So that the base station can determine that the unmanned aerial vehicle stores flight path information based on the notification information, and then obtain complete flight path information of the UAV subsequently, which improves the efficiency of reporting the flight path information of the UAV, and is simple to implement and high in usability.

In some embodiments, with reference to FIG. 3, FIG. 3 is a flowchart of an information transmission method according to an embodiment, which can be performed by an unmanned aerial vehicle, and the method may include the following steps.

At step 301, notification information is sent to a base station upon completion of a target operation.

The specific implementation of step 301 is similar to the implementation of step 101 or step 201 described above, and will not be repeated here.

At step 302, first indication information sent by the base station based on the notification information is received.

In the embodiment of the present disclosure, the first indication information instructs the unmanned aerial vehicle to report flight path information.

At step 303, the flight path information is reported to the base station based on the first indication information.

In the above embodiment, after receiving the notification information sent by the UAV, the base station can send the first indication information to the UAV to indicate the UAV to report the flight path information. Thereby improving the efficiency of reporting the flight path information of the UAV, and is simple to implement and high in usability.

In some embodiments, with reference to FIG. 4, FIG. 4 is a flowchart of an information transmission method according to an embodiment, which can be performed by an unmanned aerial vehicle, and the method may include the following steps.

At step 401, notification information is sent to a base station upon completion of a target operation.

The specific implementation of step 401 is similar to the implementation of step 101 or step 201 described above, and will not be repeated here.

At step 402, the first indication information sent by the base station through second RRC signaling based on the notification information is received.

In the embodiment of the present disclosure, the first indication information instructs the unmanned aerial vehicle to report flight path information.

In the embodiment of the present disclosure, the second RRC signaling can reuse existing RRC signaling in a protocol or it can be newly defined RRC signaling in the protocol, which is not limited by the present disclosure.

In a possible implementation, in the case of the second RRC signaling reusing the existing RRC signaling in the protocol, the second RRC signaling can specifically be user equipment information request (UEInformationRequest) signaling.

At step 403, based on the first indication information, the flight path information is reported to the base station through third RRC signaling.

In the embodiment of the present disclosure, the third RRC signaling can reuse existing RRC signaling in a protocol or it can be newly defined RRC signaling in the protocol, which is not limited by the present disclosure.

In a possible implementation, in the case of the third RRC signaling reusing the existing RRC signaling in the protocol, the third RRC signaling corresponds to the second RRC signaling, which may be user equipment information response (UEInformationResponse) signaling.

In the above embodiment, after receiving the notification information sent by the UAV, the base station can send the first indication information to the UAV through the second RRC signaling to indicate the UAV to report the flight path information. The UAV can report the flight path information through the third RRC signaling, thereby improving the efficiency of reporting the flight path information of the UAV. It is simple to implement and high in usability.

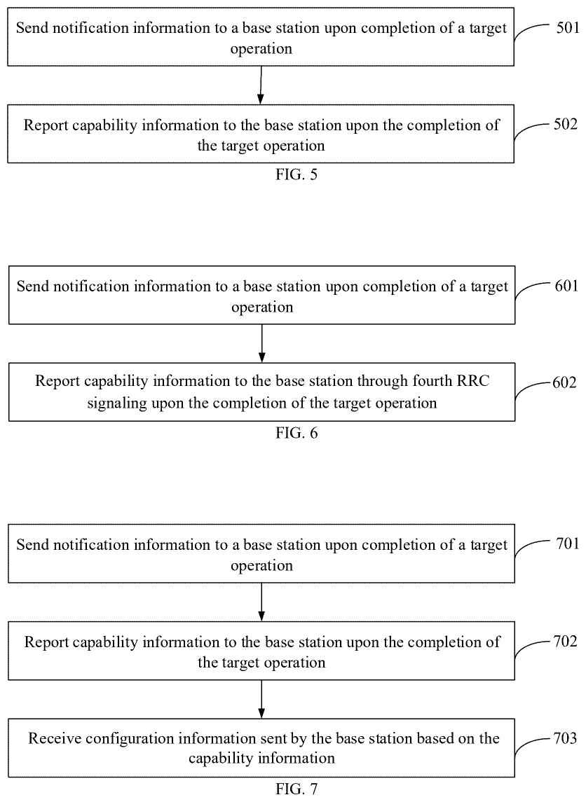

In some embodiments, with reference to FIG. 5, FIG. 5 is a flowchart of an information transmission method according to an embodiment, which can be performed by an unmanned aerial vehicle, and the method may include the following steps.

At step 501, notification information is sent to a base station upon completion of a target operation.

The specific implementation of step 501 is similar to the implementation of step 101 or step 201 described above, and will not be repeated here.

At step 502, capability information is reported to the base station upon the completion of the target operation.

In the embodiment of the present disclosure, the capability information indicates whether the unmanned aerial vehicle has a capability to report flight path information.

That is, the unmanned aerial vehicle can report the capability information to the base station upon the completion of any one of: RRC connection setup operation, RRC connection reestablishment operation, RRC resume operation, and RRC reconfiguration operation.

In the above embodiment, the UAV can report capability information to the base station upon the completion of the target operation, where the capability information indicates whether the UAV has the capability to report the flight path information. So that the base station side can configure the UAV to report the flight path information based on the capability information, the efficiency of reporting the flight path information of the unmanned aerial vehicle is improved, the realization is simple and convenient, and the usability is high.

In some embodiments, with reference to FIG. 6, FIG. 6 is a flowchart of an information transmission method according to an embodiment, which can be performed by an unmanned aerial vehicle, and the method may include the following steps.

At step 601, notification information is sent to a base station upon completion of a target operation.

The specific implementation of step 601 is similar to the implementation of step 101 or step 201 described above, and will not be repeated here.

At step 602, capability information is reported to the base station through fourth RRC signaling upon the completion of the target operation.

In the embodiment of the present disclosure, the capability information indicates whether the unmanned aerial vehicle has a capability to report flight path information. The fourth RRC signaling can reuse existing RRC signaling in a protocol or it can be newly defined RRC signaling in the protocol, which is not limited by the present disclosure.

That is, the unmanned aerial vehicle can report the capability information to the base station through the fourth RRC signaling upon the completion of any one of: RRC connection setup operation, RRC connection reestablishment operation, RRC resume operation, and RRC reconfiguration operation. The fourth RRC signaling can reuse existing RRC signaling in a protocol or it can be newly defined RRC signaling in the protocol, which is not limited by the present disclosure.

In a possible implementation, when the fourth RRC signaling reuses the existing RRC signaling in the protocol, in an LTE system, the fourth RRC signaling is specifically user equipment-evolved universal terrestrial radio access-capability (UE-EUTRA-Capability) signaling.

In an NR system, the fourth RRC signaling is specifically user equipment-new radio-capability (UE-NR-Capability) signaling.

In the above embodiment, the UAV can report capability information to the base station through the fourth RRC signaling upon the completion of the target operation, where the capability information indicates whether the UAV has the capability to report the flight path information. So that the base station side can configure the UAV to report the flight path information based on the capability information, the efficiency of reporting the flight path information of the unmanned aerial vehicle is improved, the realization is simple and convenient, and the usability is high.

In some embodiments, the capability information can be reported to the base station through a first information element in the fourth RRC signaling.

The fourth RRC signaling can reuse existing RRC signaling in a protocol or it can be newly defined RRC signaling in the protocol, and the first information element can reuse an existing information element in the existing RRC signaling, or it can be a newly defined information element in the existing RRC signaling, or a newly defined information element in the newly defined RRC signaling, which is not limited by the present disclosure.

In a possible implementation, the fourth RRC signaling can reuse the existing RRC signaling in the protocol, and the first information element can be an existing information element in the fourth RRC signaling, specifically, in the LTE system, the fourth RRC signaling is UE-EUTRA-Capability signaling, and the first information element is an OtherParameters information element in the UE-EUTRA-Capability signaling.

In the NR system, the fourth RRC signaling is UE-NR-Capability signaling, and the first information element is an OtherParameters information element in the UE-NR-Capability signaling.

In the above embodiment, the efficiency of reporting the flight path information of the UAV is improved, the implementation is simple and convenient, and the usability is high.

In some embodiments, with reference to FIG. 7, FIG. 7 is a flowchart of an information transmission method according to an embodiment, which can be performed by an unmanned aerial vehicle, and the method may include the following steps.

At step 701, notification information is sent to a base station upon completion of a target operation.

The specific implementation of step 701 is similar to the implementation of step 101 or step 201 described above, and will not be repeated here.

At step 702, capability information is reported to the base station upon the completion of the target operation.

The specific implementation of step 702 is similar to the implementation of step 502 or step 602 described above, and will not be repeated here.

At step 703, configuration information sent by the base station based on the capability information is received.

In the embodiment of the present disclosure, if the base station determines, based on the capability information, that the unmanned aerial vehicle has the capability to report the flight path information, it may send configuration information to the unmanned aerial vehicle. The configuration information is for configuring the unmanned aerial vehicle to report the flight path information.

In a possible implementation, the configuration information is for configuring at least one of: whether the unmanned aerial vehicle is allowed to report flight path information; or whether the unmanned aerial vehicle is allowed to report second indication information; where the second indication information indicates that the unmanned aerial vehicle stores flight path information.

In the above embodiment, the base station can configure the configuration information for the UAV to report flight path information based on the capability information reported by the UAV, which improves the efficiency of reporting the flight path information of the UAV, is simple to implement, and high in usability.

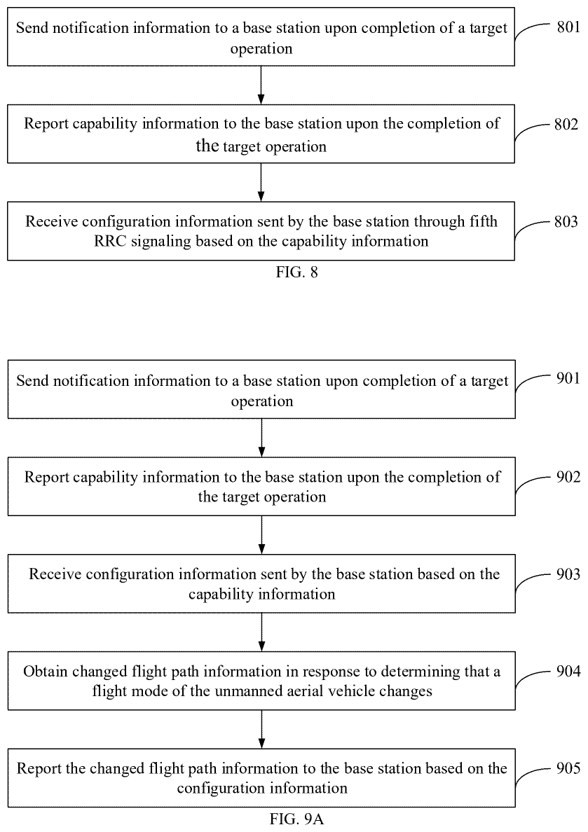

In some embodiments, with reference to FIG. 8, FIG. 8 is a flowchart of an information transmission method according to an embodiment, which can be performed by an unmanned aerial vehicle, and the method may include the following steps.

At step 801, notification information is sent to a base station upon completion of a target operation.

The specific implementation of step 801 is similar to the implementation of step 101 or step 201 described above, and will not be repeated here.

At step 802, capability information is reported to the base station upon the completion of the target operation.

The specific implementation of step 802 is similar to the implementation of step 502 or step 602 described above, and will not be repeated here.

At step 803, configuration information sent by the base station through fifth RRC signaling based on the capability information is received.

In the embodiment of the present disclosure, if the base station determines, based on the capability information, that the unmanned aerial vehicle has the capability to report the flight path information, it may send configuration information to the unmanned aerial vehicle. The configuration information is for configuring the unmanned aerial vehicle to report flight path information.

In a possible implementation, the configuration information is for configuring at least one of: whether the unmanned aerial vehicle is allowed to report flight path information; or whether the unmanned aerial vehicle is allowed to report second indication information; where the second indication information indicates that the unmanned aerial vehicle stores flight path information.

In the embodiment of the present disclosure, the fifth RRC signaling can reuse existing RRC signaling in a protocol or it can be newly defined RRC signaling in the protocol, which is not limited by the present disclosure.

In a possible implementation, when the fifth RRC signaling reuses the existing RRC signaling in the protocol, in the LTE system, the fifth RRC signaling is specifically RRC Connection Reconfiguration (RRCConnectionReconfiguration) signaling.

In the NR system, the fifth RRC signaling is specifically RRC Reconfiguration (RRCReconfiguration) signaling.

In the above embodiment, the base station can configure the configuration information for the UAV to report flight path information through the fifth RRC signaling based on the capability information reported by the UAV, which improves the efficiency of reporting the flight path information of the UAV, is simple to implement, and high in usability.

In some embodiments, the base station may send the configuration information through a second information element in the fifth RRC signaling.

In a possible implementation, the fifth RRC signaling can reuse existing RRC signaling in a protocol or it can be newly defined RRC signaling in the protocol, which is not limited by the present disclosure. The second information element can reuse an existing information element in the existing RRC signaling, or it can be a newly defined information element in the existing RRC signaling, or a newly defined information element in the newly defined RRC signaling, which is by the present disclosure.

In a possible implementation, the fifth RRC signaling can reuse the existing RRC signaling in the protocol, and the second information element can reuse an existing information element in the fifth RRC signaling.

Specifically, in the LTE system, the fifth RRC signaling is the RRCConnectionReconfiguration signaling, and the second information element is an other configuration (OtherConfig) information element in the RRCConnectionReconfiguration signaling.

In the NR system, the fifth RRC signaling is the RRCReconfiguration signaling, and the second information element is an OtherConfig information element in the RRCReconfiguration signaling.

In the above embodiment, the base station can configure the configuration information for the UAV to report flight path information through the second information element in the fifth RRC signaling based on the capability information reported by the UAV, which improves the efficiency of reporting the flight path information of the UAV, is simple to implement, and high in usability.

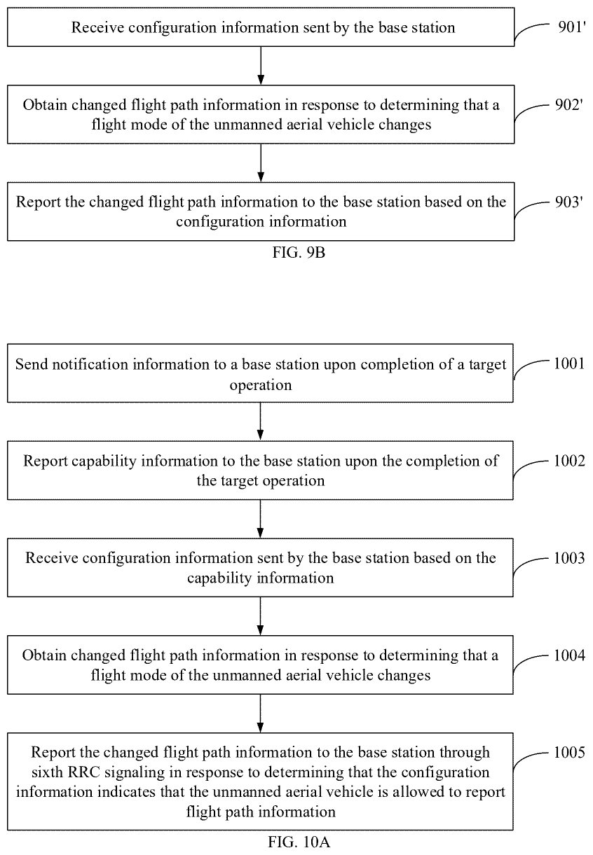

In some embodiments, with reference to FIG. 9A, FIG. 9A is a flowchart of an information transmission method according to an embodiment, which can be performed by an unmanned aerial vehicle, and the method may include the following steps.

At step 901, notification information is sent to a base station upon completion of a target operation.

The specific implementation of step 901 is similar to the implementation of step 101 or step 201 described above, and will not be repeated here.

At step 902, capability information is reported to the base station upon the completion of the target operation.

The specific implementation of step 902 is similar to the implementation of step 502 or step 602 described above, and will not be repeated here.

At step 903, configuration information sent by the base station based on the capability information is received.

The specific implementation of step 903 is similar to the implementation of step 703 or step 803 described above, and will not be repeated here.

At step 904, in response to determining that a flight mode of the unmanned aerial vehicle changes, changed flight path information is obtained.

In the embodiment of the present disclosure, the flight mode of the unmanned aerial vehicle changes, and the unmanned aerial vehicle can obtain the changed flight path information from a UAV remote controller, a UAV management platform server, the base station, a core network and other devices. The change of flight mode may be a change of flight mode of UAV from dynamic mode to fixed mode, or from fixed mode to dynamic mode, or a switch between any two flight modes.

At step 905, based on the configuration information, the changed flight path information is reported to the base station.

In the above embodiment, once the flight mode of the UAV changes, the UAV can report the changed flight path information to the base station based on the configuration information sent by the base station. The purpose of efficiently reporting flight path information when the flight mode changes is realized, and the usability is high.

In some embodiments, with reference to FIG. 9B, FIG. 9B is a flowchart of an information transmission method according to an embodiment, which can be performed by an unmanned aerial vehicle, and the method may include the following steps.

At step 901′, configuration information sent by the base station is received.

The configuration information is for configuring the unmanned aerial vehicle to report flight path information.

In a possible implementation, the configuration information is for configuring at least one of: whether the unmanned aerial vehicle is allowed to report flight path information; or whether the unmanned aerial vehicle is allowed to report second indication information; where the second indication information indicates that the unmanned aerial vehicle stores flight path information.

At step 902′, in response to determining that a flight mode of the unmanned aerial vehicle changes, changed flight path information is obtained.

In the embodiment of the present disclosure, the flight mode of the unmanned aerial vehicle changes, and the unmanned aerial vehicle can obtain the changed flight path information from a UAV remote controller, a UAV management platform server, the base station, a core network and other devices. The change of flight mode may be a change of flight mode of UAV from dynamic mode to fixed mode, or from fixed mode to dynamic mode, or a switch between any two flight modes.

At step 903′, based on the configuration information, the changed flight path information is reported to the base station.

In the above embodiment, once the flight mode of the UAV changes, the UAV can report the changed flight path information to the base station based on the configuration information sent by the base station. The purpose of efficiently reporting flight path information when the flight mode changes is realized, and the usability is high.

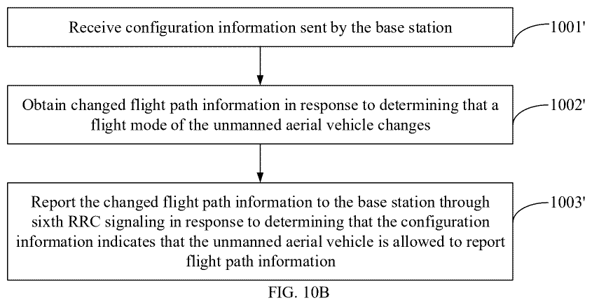

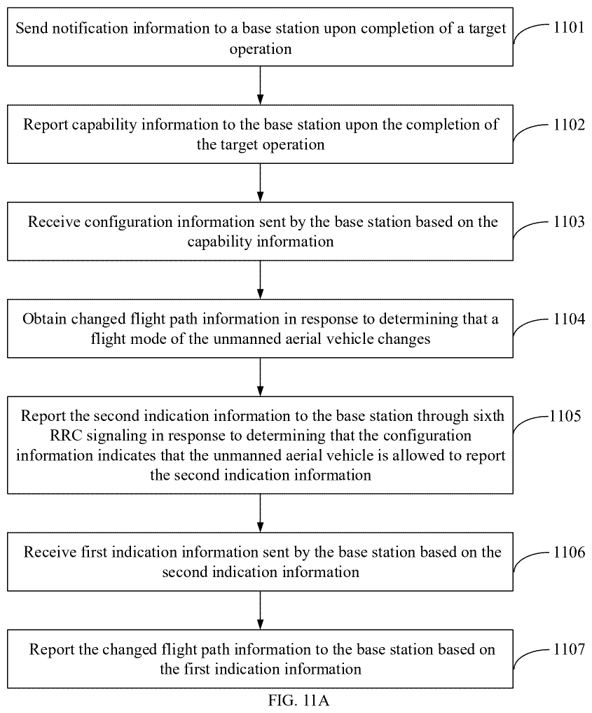

In some embodiments, with reference to FIG. 10A, FIG. 10A is a flowchart of an information transmission method according to an embodiment, which can be performed by an unmanned aerial vehicle, and the method may include the following steps.

At step 1001, notification information is sent to a base station upon completion of a target operation.

The specific implementation of step 1001 is similar to the implementation of step 101 or step 201 described above, and will not be repeated here.

At step 1002, capability information is reported to the base station upon the completion of the target operation.

The specific implementation of step 1002 is similar to the implementation of step 502 or step 602 described above, and will not be repeated here.

At step 1003, configuration information sent by the base station based on the capability information is received.

The specific implementation of step 1003 is similar to the implementation of step 703 or step 803 described above, and will not be repeated here.

At step 1004, in response to determining that a flight mode of the unmanned aerial vehicle changes, changed flight path information is obtained.

In the embodiment of the present disclosure, the flight mode of the unmanned aerial vehicle changes, and the unmanned aerial vehicle can obtain the changed flight path information from a UAV remote controller, a UAV management platform server, the base station, a core network and other devices. The change of flight mode may be a change of flight mode of UAV from dynamic mode to fixed mode, or from fixed mode to dynamic mode, or a switch between any two flight modes.

At step 1005, in response to determining that the configuration information indicates that the unmanned aerial vehicle is allowed to report flight path information, the changed flight path information is reported to the base station through sixth RRC signaling.

In the embodiment of the present disclosure, if the unmanned aerial vehicle determines, based on the configuration information, that the base station allows the unmanned aerial vehicle to report the flight path information, it can report the changed flight path information to the base station through the sixth RRC signaling.

In the embodiment of the present disclosure, the sixth RRC signaling can reuse existing RRC signaling in a protocol or it can be newly defined RRC signaling in the protocol, which is not limited by the present disclosure.

In a possible implementation, the sixth RRC signaling reuses the existing RRC signaling in the protocol, and it may specifically be user equipment assistance information (UEAssistanceInformation) signaling.

In the above embodiment, the UAV can directly report the changed flight path information to the base station through the sixth RRC signaling, thus achieving the purpose of efficiently reporting the flight path information when the flight mode changes, which is simple to implement and high in usability.

In some embodiments, with reference to FIG. 10B, FIG. 10B is a flowchart of an information transmission method according to an embodiment, which can be performed by an unmanned aerial vehicle, and the method may include the following steps.

At step 1001′, configuration information sent by the base station is received.

The configuration information is for configuring the unmanned aerial vehicle to report flight path information.

In a possible implementation, the configuration information is for configuring at least one of: whether the unmanned aerial vehicle is allowed to report flight path information; or whether the unmanned aerial vehicle is allowed to report second indication information; where the second indication information indicates that the unmanned aerial vehicle stores flight path information.

At step 1002′, in response to determining that a flight mode of the unmanned aerial vehicle changes, changed flight path information is obtained.

In the embodiment of the present disclosure, the flight mode of the unmanned aerial vehicle changes, and the unmanned aerial vehicle can obtain the changed flight path information from a UAV remote controller, a UAV management platform server, the base station, a core network and other devices. The change of flight mode may be a change of flight mode of UAV from dynamic mode to fixed mode, or from fixed mode to dynamic mode, or a switch between any two flight modes.

At step 1003′, in response to determining that the configuration information indicates that the unmanned aerial vehicle is allowed to report flight path information, the changed flight path information is reported to the base station through sixth RRC signaling.

In the embodiment of the present disclosure, if the unmanned aerial vehicle determines, based on the configuration information, that the base station allows the unmanned aerial vehicle to report the flight path information, it can report the changed flight path information to the base station through the sixth RRC signaling.

In the embodiment of the present disclosure, the sixth RRC signaling can reuse existing RRC signaling in a protocol or it can be newly defined RRC signaling in the protocol, which is not limited by the present disclosure.

In a possible implementation, the sixth RRC signaling reuses the existing RRC signaling in the protocol, and it may specifically be UEAssistanceInformation signaling.

In the above embodiment, the UAV can directly report the changed flight path information to the base station through the sixth RRC signaling, thus achieving the purpose of efficiently reporting the flight path information when the flight mode changes, which is simple to implement and high in usability.

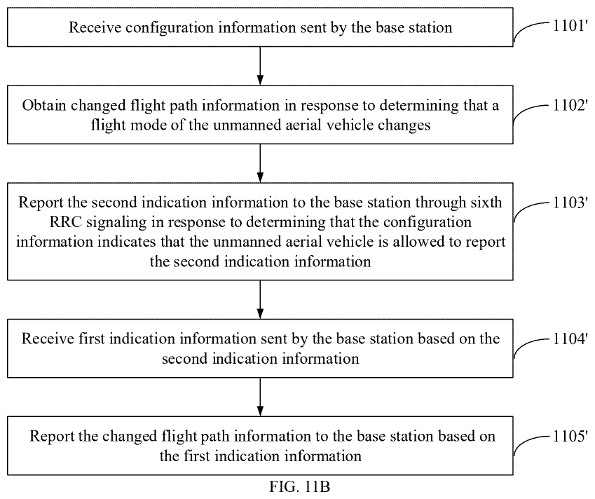

In some embodiments, with reference to FIG. 11A, FIG. 11A is a flowchart of an information transmission method according to an embodiment, which can be performed by an unmanned aerial vehicle, and the method may include the following steps.

At step 1101, notification information is sent to a base station upon completion of a target operation.

The specific implementation of step 1101 is similar to the implementation of step 101 or step 201 described above, and will not be repeated here.

At step 1102, capability information is reported to the base station upon the completion of the target operation.

The specific implementation of step 1102 is similar to the implementation of step 502 or step 602 described above, and will not be repeated here.

At step 1103, configuration information sent by the base station based on the capability information is received.

The specific implementation of step 1103 is similar to the implementation of step 703 or step 803 described above, and will not be repeated here.

At step 1104, in response to determining that a flight mode of the unmanned aerial vehicle changes, changed flight path information is obtained.

In the embodiment of the present disclosure, the flight mode of the unmanned aerial vehicle changes, and the unmanned aerial vehicle can obtain the changed flight path information from a UAV remote controller, a UAV management platform server, the base station, a core network and other devices. The change of flight mode may be a change of flight mode of UAV from dynamic mode to fixed mode, or from fixed mode to dynamic mode, or a switch between any two flight modes.

At step 1105, in response to determining that the configuration information indicates that the unmanned aerial vehicle is allowed to report the second indication information, the second indication information is reported to the base station through sixth RRC signaling.

In the embodiment of the present disclosure, if the unmanned aerial vehicle determines that the base station allows the unmanned aerial vehicle to report the second indication information based on the configuration information, and the second indication information indicates that the unmanned aerial vehicle stores the flight path information, then the unmanned aerial vehicle can report the second indication information to the base station through the sixth RRC signaling.

In a possible implementation, the sixth RRC signaling can reuse existing RRC signaling in a protocol or it can be newly defined RRC signaling in the protocol, which is not limited by the present disclosure.

In a possible implementation, the sixth RRC signaling reuses the existing RRC signaling in the protocol, and it may specifically be UEAssistanceInformation signaling.

At step 1106, first indication information sent by the base station based on the second indication information is received.

The first indication information instructs the unmanned aerial vehicle to report flight path information.

At step 1107, the changed flight path information is reported to the base station based on the first indication information.

In the above embodiment, the UAV can report, based on the configuration information, the second indication information to the base station through the sixth RRC signaling, and report the changed flight path information to the base station after receiving the first indication information sent by the base station. The purpose of reporting flight path information efficiently when the flight mode changes is realized is simple to realize and high in usability.

In some embodiments, with reference to FIG. 11B, FIG. 11B is a flowchart of an information transmission method according to an embodiment, which can be performed by an unmanned aerial vehicle, and the method may include the following steps.

At step 1101′, configuration information sent by the base station is received.

The configuration information is used to configure the unmanned aerial vehicle to report flight path information.

In a possible implementation, the configuration information is for configuring at least one of: whether the unmanned aerial vehicle is allowed to report flight path information; or whether the unmanned aerial vehicle is allowed to report second indication information; where the second indication information indicates that the unmanned aerial vehicle stores flight path information.

At step 1102′, in response to determining that a flight mode of the unmanned aerial vehicle changes, changed flight path information is obtained.

In the embodiment of the present disclosure, the flight mode of the unmanned aerial vehicle changes, and the unmanned aerial vehicle can obtain the changed flight path information from a UAV remote controller, a UAV management platform server, the base station, a core network and other devices. The change of flight mode may be a change of flight mode of UAV from dynamic mode to fixed mode, or from fixed mode to dynamic mode, or a switch between any two flight modes.

At step 1103′, in response to determining that the configuration information indicates that the unmanned aerial vehicle is allowed to report the second indication information, the second indication information is reported to the base station through sixth RRC signaling.

In the embodiment of the present disclosure, if the unmanned aerial vehicle determines that the base station allows the unmanned aerial vehicle to report the second indication information based on the configuration information, and the second indication information indicates that the unmanned aerial vehicle stores the flight path information, then the unmanned aerial vehicle can report the second indication information to the base station through the sixth RRC signaling.

In a possible implementation, the sixth RRC signaling can reuse existing RRC signaling in a protocol or it can be newly defined RRC signaling in the protocol, which is not limited by the present disclosure.

In a possible implementation, the sixth RRC signaling reuses the existing RRC signaling in the protocol, and it may specifically be UEAssistanceInformation signaling.

At step 1104′, first indication information sent by the base station based on the second indication information is received.

The first indication information instructs the unmanned aerial vehicle to report flight path information.

At step 1105′, the changed flight path information is reported to the base station based on the first indication information.

In the above embodiment, the UAV can report, based on the configuration information, the second indication information to the base station through the sixth RRC signaling, and report the changed flight path information to the base station after receiving the first indication information sent by the base station. The purpose of reporting flight path information efficiently when the flight mode changes is realized, which is simple to realize and high in usability.

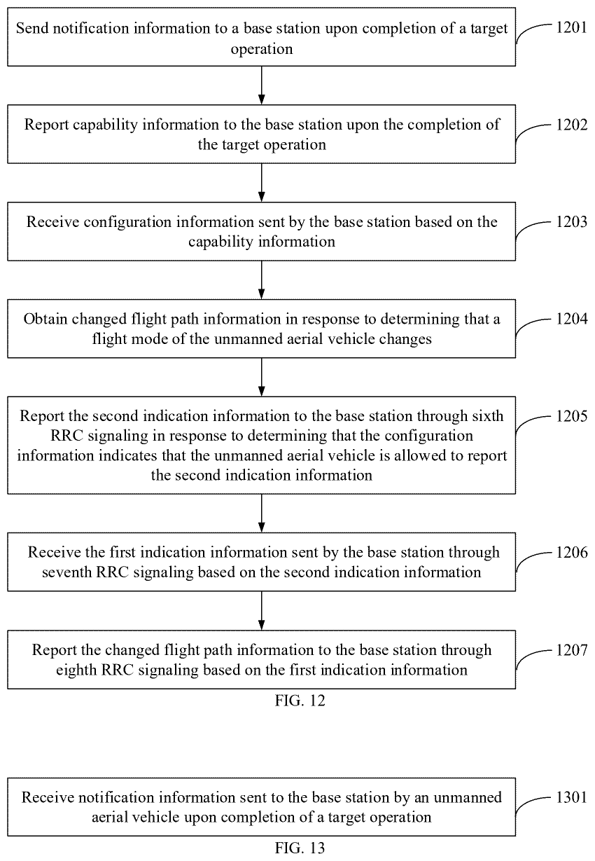

In some embodiments, with reference to FIG. 12, FIG. 12 is a flowchart of an information transmission method according to an embodiment, which can be performed by an unmanned aerial vehicle, and the method may include the following steps.

At step 1201, notification information is sent to a base station upon completion of a target operation.

The specific implementation of step 1201 is similar to the implementation of step 101 or step 201 described above, and will not be repeated here.

At step 1202, capability information is reported to the base station upon the completion of the target operation.

The specific implementation of step 1202 is similar to the implementation of step 502 or step 502 described above, and will not be repeated here.

At step 1203, configuration information sent by the base station based on the capability information is received.

The specific implementation of step 1203 is similar to the implementation of step 703 or step 803 described above, and will not be repeated here.

At step 1204, in response to determining that a flight mode of the unmanned aerial vehicle changes, changed flight path information is obtained.

In the embodiment of the present disclosure, the flight mode of the unmanned aerial vehicle changes, and the unmanned aerial vehicle can obtain the changed flight path information from a UAV remote controller, a UAV management platform server, the base station, a core network and other devices. The change of flight mode may be a change of flight mode of UAV from dynamic mode to fixed mode, or from fixed mode to dynamic mode, or a switch between any two flight modes.

At step 1205, in response to determining that the configuration information indicates that the unmanned aerial vehicle is allowed to report the second indication information, the second indication information is reported to the base station through sixth RRC signaling.

In the embodiment of the present disclosure, if the unmanned aerial vehicle determines that the base station allows the unmanned aerial vehicle to report the second indication information based on the configuration information, and the second indication information indicates that the unmanned aerial vehicle stores the flight path information, the unmanned aerial vehicle can report the second indication information to the base station through the sixth RRC signaling.

In a possible implementation, the sixth RRC signaling can reuse existing RRC signaling in a protocol or it can be newly defined RRC signaling in the protocol, which is not limited by the present disclosure.

In a possible implementation, the sixth RRC signaling reuses the existing RRC signaling in the protocol, and it may specifically be UEAssistanceInformation signaling.

At step 1206, the first indication information sent by the base station through seventh RRC signaling based on the second indication information is received.

In the embodiment of the present disclosure, the seventh RRC signaling can reuse existing RRC signaling in a protocol or it can be newly defined RRC signaling in the protocol, which is not limited by the present disclosure.

In a possible implementation, the seventh RRC signaling reuses the existing RRC signaling in the protocol, and it may specifically be UEInformationRequest signaling.

At step 1207, based on the first indication information, the changed flight path information is reported to the base station through eighth RRC signaling.

In a possible implementation, the eighth RRC signaling can reuse existing RRC signaling in a protocol or it can be newly defined RRC signaling in the protocol, which is not limited by the present disclosure.

In a possible implementation, the eighth RRC signaling reuses the existing RRC signaling in the protocol, and corresponds to the seventh RRC signaling, the eighth RRC signaling may specifically be UEInformationResponse signaling.

In the above embodiment, the base station can send the first indication information to the UAV through the seventh RRC signaling, and the UAV can report the changed flight path information to the base station through the eighth RRC signaling. The purpose of reporting flight path information efficiently when the flight mode changes is realized, which is simple to realize and high in usability.

Next, the information transmission method provided by the present disclosure will be introduced from a base station side.

An embodiment of the present disclosure provides an information transmission method, referring to FIG. 13, FIG. 13 is a flowchart of an information transmission method according to an embodiment, which can be performed by a base station, and the method may include the following step.

At step 1301, notification information sent to the base station by an unmanned aerial vehicle upon completion of a target operation is received.

In the embodiment of the present disclosure, the target operation is an operation associated with an RRC connection between the unmanned aerial vehicle and the base station, and the notification information informs the base station that the unmanned aerial vehicle stores flight path information. The flight path information may be flight path information of the unmanned aerial vehicle in a fixed mode or flight path information of the unmanned aerial vehicle in a dynamic mode, which is not limited by the present disclosure.

In a possible implementation, the completion of a target operation includes any one of: completion of an RRC connection setup operation; completion of an RRC connection reestablishment operation; completion of an RRC restart operation; and completion of an RRC reconfiguration operation.

In the above embodiment, the base station can receive the notification information sent by the UAV when the UAV completes the target operation, where the target operation is an operation associated with the RRC connection between the unmanned aerial vehicle and the base station, and the notification information informs the base station that the unmanned aerial vehicle stores flight path information. So that the base station can determine that the unmanned aerial vehicle stores flight path information based on the notification information, and then obtain complete flight path information of the UAV subsequently, which improves the efficiency of reporting the flight path information of the UAV, and is simple to implement and high in usability.

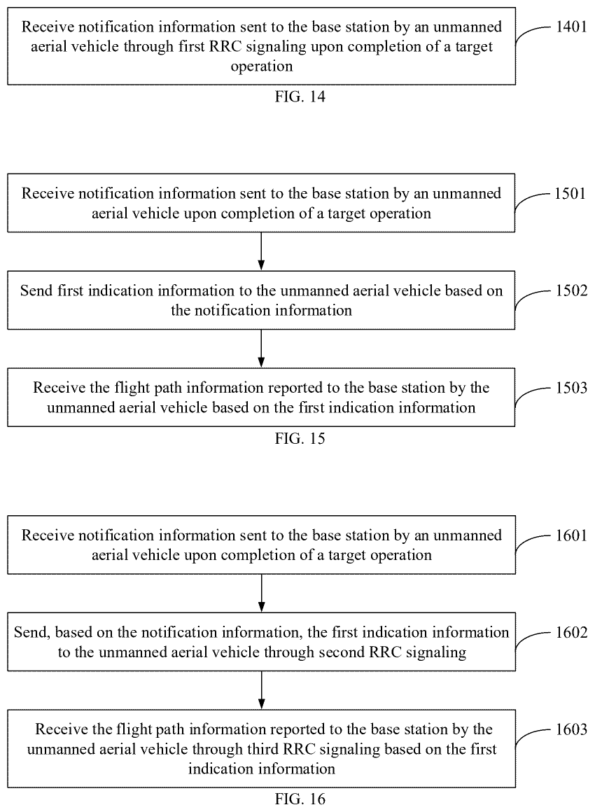

In some embodiments, with reference to FIG. 14, FIG. 14 is a flowchart of an information transmission method according to an embodiment, which can be performed by a base station, and the method may include the following step.

At step 1401, notification information sent to the base station by an unmanned aerial vehicle through first RRC signaling upon completion of a target operation is received.

In the embodiment of the present disclosure, the target operation is an operation associated with an RRC connection between the unmanned aerial vehicle and the base station, and the notification information informs the base station that the unmanned aerial vehicle stores flight path information. The flight path information may be flight path information of the unmanned aerial vehicle in a fixed mode or flight path information of the unmanned aerial vehicle in a dynamic mode, which is not limited by the present disclosure.

In a possible implementation, the completion of a target operation includes any one of: completion of an RRC connection setup operation; completion of an RRC connection reestablishment operation; completion of an RRC restart operation; and completion of an RRC reconfiguration operation.

In the embodiment of the present disclosure, the first RRC signaling can reuse existing RRC signaling in a protocol or it can be newly defined RRC signaling in the protocol, which is not limited by the present disclosure.

In a possible implementation, when the first RRC signaling reuses the existing RRC signaling in the protocol, and in case of the NR network, the first RRC signaling may be any one of: RRCSetupComplete signaling; RRCReestablishmentComplete signaling; RRCResumeComplete signaling; and RRCReconfigurationComplete signaling.

Specifically, the first RRC signaling corresponds to the target operation. Upon completion of an RRC connection setup operation, the unmanned aerial vehicle can send the notification information to the base station through RRCSetupComplete signaling.

Upon completion of an RRC connection reestablishment operation, the unmanned aerial vehicle can send the notification information to the base station through RRCReestablishmentComplete signaling.

Upon completion of an RRC resume operation, the unmanned aerial vehicle can send the notification information to the base station through RRCResumeComplete signaling.

Upon completion of an RRC reconfiguration operation, the unmanned aerial vehicle can send the notification information to the base station through RRCReconfigurationComplete signaling.

In another possible implementation, in case of the LTE network, the first RRC signaling be one may any of: RRCConnectionSetupComplete signaling; RRCConnectionReestablishmentComplete signaling; RRCConnectionResumeComplete signaling; and RRCConnectionReconfigurationComplete signaling.

Specifically, the first RRC signaling corresponds to the target operation. Upon completion of an RRC connection setup operation, the unmanned aerial vehicle can send the notification information to the base station through RRCConnectionSetupComplete signaling.

Upon completion of an RRC connection reestablishment operation, the unmanned aerial vehicle can send the notification information to the base station through RRCConnectionReestablishmentComplete signaling.

Upon completion of an RRC resume operation, the unmanned aerial vehicle can send the notification information to the base station through RRCConnectionResumeComplete signaling.

Upon completion of an RRC reconfiguration operation, the unmanned aerial vehicle can send the notification information to the base station through RRCConnectionReconfigurationComplete signaling.

In the above embodiment, the base station can receive the notification information sent by the UAV through the first RRC signaling upon completion of the target operation, where the target operation is an operation associated with the RRC connection between the unmanned aerial vehicle and the base station, and the notification information informs the base station that the unmanned aerial vehicle stores flight path information. So that the base station can determine that the unmanned aerial vehicle stores flight path information based on the notification information, and then obtain complete flight path information of the UAV subsequently, which improves the efficiency of reporting the flight path information of the UAV, and is simple to implement and high in usability.

In some embodiments, with reference to FIG. 15, FIG. 15 is a flowchart of an information transmission method according to an embodiment, which can be performed by a base station, and the method may include the following steps.

At step 1501, notification information sent to the base station by an unmanned aerial vehicle upon completion of a target operation is received.

The implementation of step 1501 is similar to the step 1301 or 1401, which is not repeated here.

At step 1502, first indication information is sent to the unmanned aerial vehicle based on the notification information.

The first indication information instructs the unmanned aerial vehicle to report flight path information.

At step 1503, the flight path information reported to the base station by the unmanned aerial vehicle based on the first indication information is received.

In the above embodiment, after receiving the notification information sent by the UAV, the base station can send the first indication information to the UAV to indicate the UAV to report the flight path information. Thereby improving the efficiency of reporting the flight path information of the UAV, and is simple to implement and high in usability.

In some embodiments, with reference to FIG. 16, FIG. 16 is a flowchart of an information transmission method according to an embodiment, which can be performed by a base station, and the method may include the following steps.

At step 1601, notification information sent to the base station by an unmanned aerial vehicle upon completion of a target operation is received.

The implementation of step 1601 is similar to the step 1301 or 1401, which is not repeated here.

At step 1602, based on the notification information, the first indication information is sent to the unmanned aerial vehicle through second RRC signaling.

In the embodiment of the present disclosure, the first indication information instructs the unmanned aerial vehicle to report flight path information.

In the embodiment of the present disclosure, the second RRC signaling can reuse existing RRC signaling in a protocol or it can be newly defined RRC signaling in the protocol, which is not limited by the present disclosure.

In a possible implementation, in the case of the second RRC signaling reusing the existing RRC signaling in the protocol, the second RRC signaling may be UEInformationRequest signaling.

At step 1603, the flight path information reported to the base station by the unmanned aerial vehicle through third RRC signaling based on the first indication information is received.

In the embodiment of the present disclosure, the third RRC signaling can reuse existing RRC signaling in a protocol or it can be newly defined RRC signaling in the protocol, which is not limited by the present disclosure.

In a possible implementation, in the case of the third RRC signaling reusing the existing RRC signaling in the protocol, the third RRC signaling corresponds to the second RRC signaling, which may be UEInformationResponse signaling.

In the above embodiment, after receiving the notification information sent by the UAV, the base station can send the first indication information to the UAV through the second RRC signaling to indicate the UAV to report the flight path information. The UAV can report the flight path information through the third RRC signaling, thereby improving the efficiency of reporting the flight path information of the UAV, and is simple to implement and high in usability.

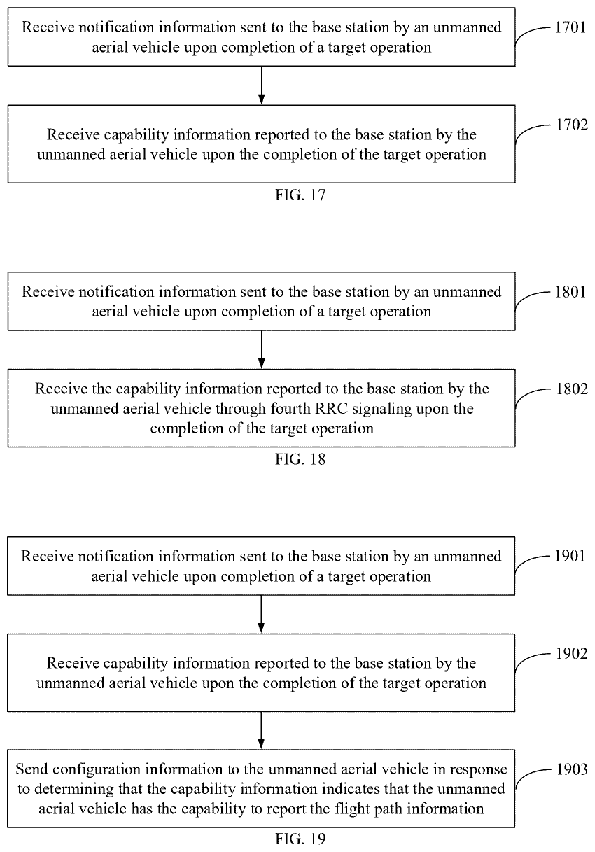

In some embodiments, with reference to FIG. 17, FIG. 17 is a flowchart of an information transmission method according to an embodiment, which can be performed by a base station, and the method may include the following steps.

At step 1701, notification information sent to the base station by an unmanned aerial vehicle upon completion of a target operation is received.

The implementation of step 1701 is similar to the step 1301 or 1401, which is not repeated here.

At step 1702, capability information reported to the base station by the unmanned aerial vehicle upon the completion of the target operation is received.

In the embodiment of the present disclosure, the capability information indicates whether the unmanned aerial vehicle has a capability to report flight path information.

That is, the unmanned aerial vehicle can report the capability information to the base station upon the completion of any one of: RRC connection setup operation, RRC connection reestablishment operation, RRC resume operation, and RRC reconfiguration operation.

In the above embodiment, the UAV can report capability information to the base station upon the completion of the target operation, where the capability information indicates whether the UAV has the capability to report the flight path information. So that the base station side can configure the UAV to report the flight path information based on the capability information, the efficiency of reporting the flight path information of the unmanned aerial vehicle is improved, the realization is simple and convenient, and the usability is high.

In some embodiments, with reference to FIG. 18, FIG. 18 is a flowchart of an information transmission method according to an embodiment, which can be performed by a base station, and the method may include the following steps.

At step 1801, notification information sent to the base station by an unmanned aerial vehicle upon completion of a target operation is received.

The implementation of step 1801 is similar to the step 1301 or 1401, which is not repeated here.

At step 1802, the capability information reported to the base station by the unmanned aerial vehicle through fourth RRC signaling upon the completion of the target operation is received.

In the embodiment of the present disclosure, the capability information indicates whether the unmanned aerial vehicle has a capability to report flight path information.

That is, the unmanned aerial vehicle can report the capability information to the base station through the fourth RRC signaling upon the completion of any one of: RRC connection setup operation, RRC connection reestablishment operation, RRC resume operation, and RRC reconfiguration operation. The fourth RRC signaling can reuse existing RRC signaling in a protocol or it can be newly defined RRC signaling in the protocol, which is not limited by the present disclosure.

In a possible implementation, when the fourth RRC signaling reuses the existing RRC signaling in the protocol, in the LTE system, the fourth RRC signaling is specifically UE-EUTRA-Capability signaling.

In the NR system, the fourth RRC signaling is specifically UE-NR-Capability signaling.

In the above embodiment, the UAV can report capability information to the base station through the fourth RRC signaling upon the completion of the target operation, where the capability information indicates whether the UAV has the capability to report the flight path information. So that the base station side can configure the UAV to report the flight path information based on the capability information, the efficiency of reporting the flight path information of the unmanned aerial vehicle is improved, the realization is simple and convenient, and the usability is high.

In some embodiments, the UAV may report the capability information to the base station through a first information element in the fourth RRC signaling.

The fourth RRC signaling can reuse existing RRC signaling in a protocol or it can be newly defined RRC signaling in the protocol, and the first information element can reuse an existing information element in the existing RRC signaling, or it can be a newly defined information element in the existing RRC signaling, or a newly defined information element in the newly defined RRC signaling, which is not limited by the present disclosure.

In a possible implementation, the fourth RRC signaling can reuse the existing RRC signaling in the protocol, and the first information element can be an existing information element in the fourth RRC signaling, specifically, in the LTE system, the fourth RRC signaling is UE-EUTRA-Capability signaling, and the first information element is an OtherParameters information element in the UE-EUTRA-Capability signaling.

In the NR system, the fourth RRC signaling is UE-NR-Capability signaling, and the first information element is an OtherParameters information element in the UE-NR-Capability signaling.

In the above embodiment, the efficiency of reporting the flight path information of the UAV is improved, the implementation is simple and convenient, and the usability is high.

In some embodiments, with reference to FIG. 19, FIG. 19 is a flowchart of an information transmission method according to an embodiment, which can be performed by a base station, and the method may include the following steps.

At step 1901, notification information sent to the base station by an unmanned aerial vehicle upon completion of a target operation is received.

The implementation of step 1901 is similar to the step 1301 or 1401, which is not repeated here.

At step 1902, capability information reported to the base station by the unmanned aerial vehicle upon the completion of the target operation is received.

The implementation of step 1902 is similar to the step 1702 or 1802, which is not repeated here.

At step 1903, in response to determining that the capability information indicates that the unmanned aerial vehicle has the capability to report the flight path information, configuration information is sent to the unmanned aerial vehicle.

In the embodiment of the present disclosure, if the base station determines, based on the capability information, that the unmanned aerial vehicle has the capability to report the flight path information, it may send configuration information to the unmanned aerial vehicle. The configuration information is for configuring the unmanned aerial vehicle to report flight path information.

In a possible implementation, the configuration information is for configuring at least one of: whether the unmanned aerial vehicle is allowed to report flight path information; or whether the unmanned aerial vehicle is allowed to report second indication information; where the second indication information indicates that the unmanned aerial vehicle stores flight path information.

In the above embodiment, the base station can configure the configuration information for the UAV to report flight path information based on the capability information reported by the UAV, which improves the efficiency of reporting the flight path information of the UAV, is simple to implement, and high in usability.

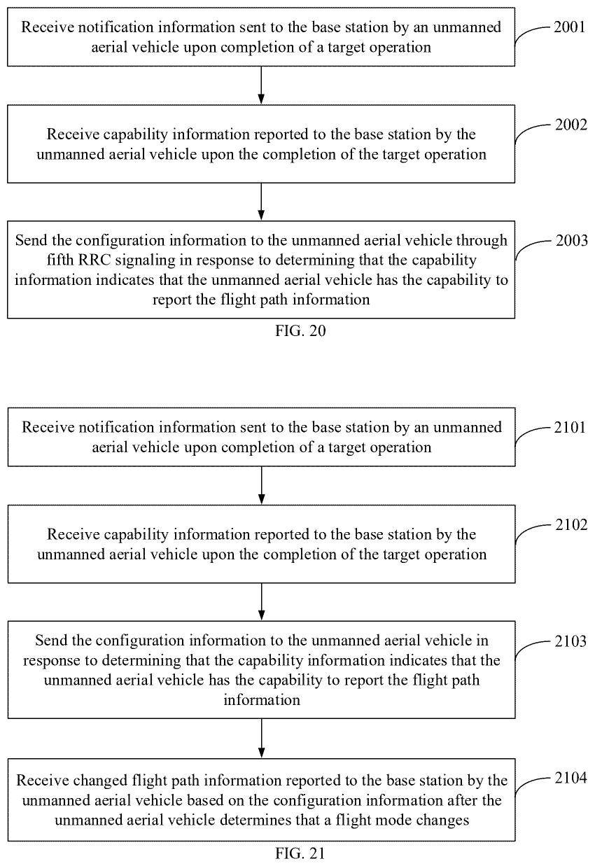

In some embodiments, with reference to FIG. 20, FIG. 20 is a flowchart of an information transmission method according to an embodiment, which can be performed by a base station, and the method may include the following steps.

At step 2001, notification information sent to the base station by an unmanned aerial vehicle upon completion of a target operation is received.

The implementation of step 2001 is similar to the step 1301 or 1401, which is not repeated here.

At step 2002, capability information reported to the base station by the unmanned aerial vehicle upon the completion of the target operation is received.

The implementation of step 2002 is similar to the step 1702 or 1802, which is not repeated here.

At step 2003, in response to determining that the capability information indicates that the unmanned aerial vehicle has the capability to report the flight path information, the configuration information is sent to the unmanned aerial vehicle through fifth RRC signaling.

In the embodiment of the present disclosure, if the base station determines, based on the capability information, that the unmanned aerial vehicle has the capability to report the flight path information, it may send configuration information to the unmanned aerial vehicle. The configuration information is for configuring the unmanned aerial vehicle to report flight path information.

In a possible implementation, the configuration information is for configuring at least one of: whether the unmanned aerial vehicle is allowed to report flight path information; or whether the unmanned aerial vehicle is allowed to report second indication information; where the second indication information indicates that the unmanned aerial vehicle stores flight path information.

In the embodiment of the present disclosure, the fifth RRC signaling can reuse existing RRC signaling in a protocol or it can be newly defined RRC signaling in the protocol, which is not limited by the present disclosure.

In a possible implementation, when the fifth RRC signaling reuses the existing RRC signaling in the protocol, in the LTE system, the fifth RRC signaling is specifically RRC Connection Reconfiguration (RRCConnectionReconfiguration) signaling.

In the NR system, the fifth RRC signaling is specifically RRC Reconfiguration (RRCReconfiguration) signaling.

In the above embodiment, the base station can configure the configuration information for the UAV to report flight path information through the fifth RRC signaling based on the capability information reported by the UAV, which improves the efficiency of reporting the flight path information of the UAV, is simple to implement, and high in usability. In some embodiments, the base station may send the configuration information through a second information element in the fifth RRC signaling.

In a possible implementation, the fifth RRC signaling can reuse existing RRC signaling in a protocol or it can be newly defined RRC signaling in the protocol, which is not limited by the present disclosure. The second information element can reuse an existing information element in the existing RRC signaling, or it can be a newly defined information element in the existing RRC signaling, or a newly defined information element in the newly defined RRC signaling, which is by the present disclosure.

In a possible implementation, the fifth RRC signaling can reuse the existing RRC signaling in the protocol, and the second information element can be an existing information element in the fifth RRC signaling. Specifically, in the LTE system, the fifth RRC signaling is the RRCConnectionReconfiguration signaling, and the second information element is an OtherConfig information element in the RRCConnectionReconfiguration signaling.

In the NR system, the fifth RRC signaling is the RRCReconfiguration signaling, and the second information element is an OtherConfig information element in the RRCReconfiguration signaling.

In the above embodiment, the base station can configure the configuration information for the UAV to report flight path information through the second information element in the fifth RRC signaling based on the capability information reported by the UAV, which improves the efficiency of reporting the flight path information of the UAV, is simple to implement, and high in usability.

In some embodiments, with reference to FIG. 21, FIG. 21 is a flowchart of an information transmission method according to an embodiment, which can be performed by a base station, and the method may include the following steps.

At step 2101, notification information is received from an unmanned aerial vehicle sent to the base station upon completion of a target operation.

The implementation of step 2101 is similar to the step 1301 or 1401, which is not repeated here.

At step 2102, capability information reported to the base station by the unmanned aerial vehicle upon the completion of the target operation is received.

The implementation of step 2102 is similar to the step 1702 or 1802, which is not repeated here.

At step 2103, in response to determining that the capability information indicates that the unmanned aerial vehicle has the capability to report the flight path information, the configuration information is sent to the unmanned aerial vehicle.

The implementation of step 2103 is similar to the step 1903 or 2003, which is not repeated here.

At step 2104, changed flight path information reported to the base station by the unmanned aerial vehicle based on the configuration information after the unmanned aerial vehicle determines that a flight mode changes is received.

In the embodiment of the present disclosure, the flight mode of the unmanned aerial vehicle changes, and the unmanned aerial vehicle can obtain the changed flight path information from a UAV remote controller, a UAV management platform server, the base station, a core network and other devices. The change of flight mode may be a change of flight mode of UAV from dynamic mode to fixed mode, or from fixed mode to dynamic mode, or a switch between any two flight modes.

Further, the UAV can report the changed flight path information to the base station based on the configuration information.

In the above embodiment, once the flight mode of the UAV changes, the base station can receive the changed flight path information reported to the base station by the UAV based on the configuration information sent by the base station. The purpose of efficiently reporting flight path information when the flight mode changes is realized, and the usability is high.

In some embodiments, the base station side may also send configuration information directly to the UAV, and the UAV, after the flight mode is changed, obtains the changed flight path information and reports the changed flight path information based on the configuration information. The specific implementation is similar to the process shown in FIG. 9B, and will not be described here.

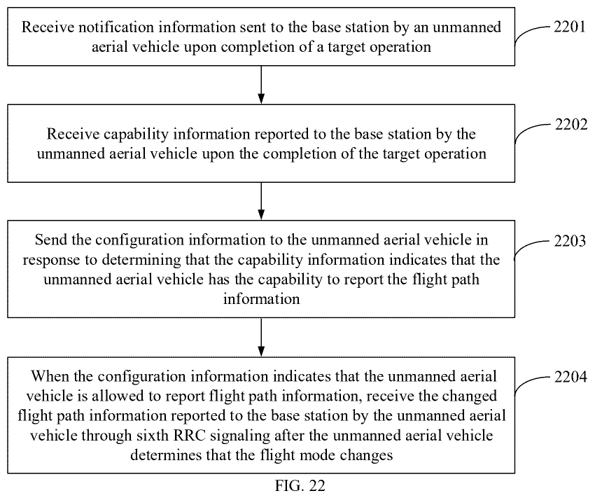

In some embodiments, with reference to FIG. 22, FIG. 22 is a flowchart of an information transmission method according to an embodiment, which can be performed by a base station, and the method may include the following steps.

At step 2201, notification information sent to the base station by an unmanned aerial vehicle upon completion of a target operation is received.

The implementation of step 2201 is similar to the step 1301 or 1401, which is not repeated here.

At step 2202, capability information reported to the base station by the unmanned aerial vehicle upon the completion of the target operation is received.

The implementation of step 2202 is similar to the step 1702 or 1802, which is not repeated here.

At step 2203, in response to determining that the capability information indicates that the unmanned aerial vehicle has the capability to report the flight path information, the configuration information is sent to the unmanned aerial vehicle.

The implementation of step 2203 is similar to the step 1903 or 2003, which is not repeated here.

At step 2204, when the configuration information indicates that the unmanned aerial vehicle is allowed to report flight path information, the changed flight path information reported to the base station by the unmanned aerial vehicle through sixth RRC signaling after the unmanned aerial vehicle determines that the flight mode changes is received.

In the embodiment of the present disclosure, if the unmanned aerial vehicle determines, based on the configuration information, that the base station allows the unmanned aerial vehicle to report the flight path information, it can report the changed flight path information to the base station through the sixth RRC signaling.

In a possible implementation, the sixth RRC signaling can reuse existing RRC signaling in a protocol or it can be newly defined RRC signaling in the protocol, which is not limited by the present disclosure.

In a possible implementation, the sixth RRC signaling reuses the existing RRC signaling in the protocol, and it may specifically be UEAssistanceInformation signaling.

In the above embodiment, the base station can receive the changed flight path information directly reported to the base station by the UAV through the sixth RRC signaling, thus achieving the purpose of efficiently reporting the flight path information when the flight mode changes, which is simple to implement and high in usability.

In some embodiments, the base station side can also directly send configuration information to the UAV, and the UAV obtains the changed flight path information after the flight mode changes, and reports the changed flight path information to the base station through the sixth RRC signaling when the configuration information indicates that the UAV is allowed to report the flight path information. The specific implementation is similar to the process shown in FIG. 10B, and will not be described here.

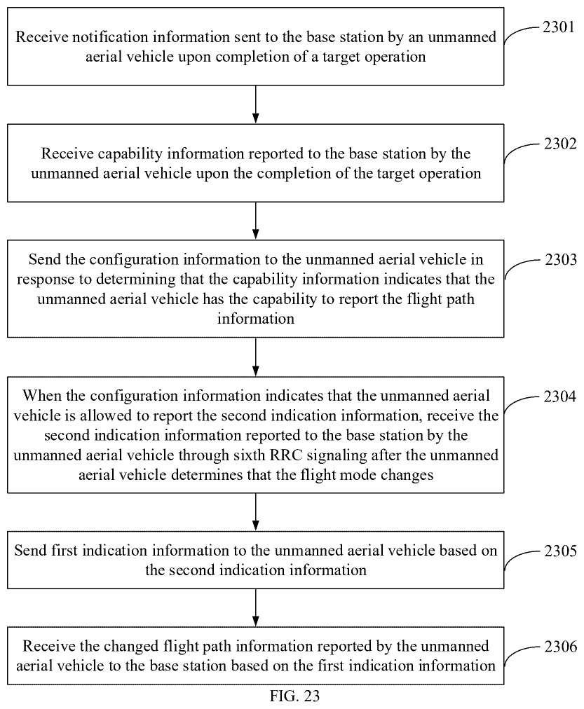

In some embodiments, with reference to FIG. 23, FIG. 23 is a flowchart of an information transmission method according to an embodiment, which can be performed by a base station, and the method may include the following steps.

At step 2301, notification information sent to the base station by an unmanned aerial vehicle upon completion of a target operation is received.

The implementation of step 2301 is similar to the step 1301 or 1401, which is not repeated here. At step 2302, capability information reported to the base station by the unmanned aerial vehicle upon the completion of the target operation is received.

The implementation of step 2302 is similar to the step 1702 or 1802, which is not repeated here.

At step 2303, in response to determining that the capability information indicates that the unmanned aerial vehicle has the capability to report the flight path information, the configuration information is sent to the unmanned aerial vehicle.

The implementation of step 2303 is similar to the step 1903 or 2003, which is not repeated here.

At step 2304, when the configuration information indicates that the unmanned aerial vehicle is allowed to report the second indication information, the second indication information reported to the base station by the unmanned aerial vehicle through sixth RRC signaling after the unmanned aerial vehicle determines that the flight mode changes is received.

In the embodiment of the present disclosure, if the unmanned aerial vehicle determines that the base station allows the unmanned aerial vehicle to report the second indication information based on the configuration information, and the second indication information indicates that the unmanned aerial vehicle stores the flight path information, then the unmanned aerial vehicle can report the second indication information to the base station through the sixth RRC signaling.

In a possible implementation, the sixth RRC signaling can reuse existing RRC signaling in a protocol or it can be newly defined RRC signaling in the protocol, which is not limited by the present disclosure.

In a possible implementation, the sixth RRC signaling reuses the existing RRC signaling in the protocol, and it may specifically be UEAssistanceInformation signaling.

At step 2305, first indication information is sent to the unmanned aerial vehicle based on the second indication information.

The first indication information instructs the unmanned aerial vehicle to report flight path information.

At step 2306, the changed flight path information reported to the base station by the unmanned aerial vehicle based on the first indication information is received.

In the above embodiment, the UAV can report, based on the configuration information, the second indication information to the base station through the sixth RRC signaling, and report the changed flight path information to the base station after receiving the first indication information sent by the base station. The purpose of reporting flight path information efficiently when the flight mode changes is realized, which is simple to realize and high in usability.

In some embodiments, the base station side can also directly send configuration information to the UAV, the UAV obtains the changed flight path information after the flight mode changes, and reports the second indication information to the base station through the sixth RRC signaling when the configuration information indicates that the UAV is allowed to report the second indication information. Further, the base station will send the first indication information to the UAV, and the UAV will report the changed flight path information to the base station based on the first indication information. The specific implementation is similar to the process shown in FIG. 11B, and will not be described here.

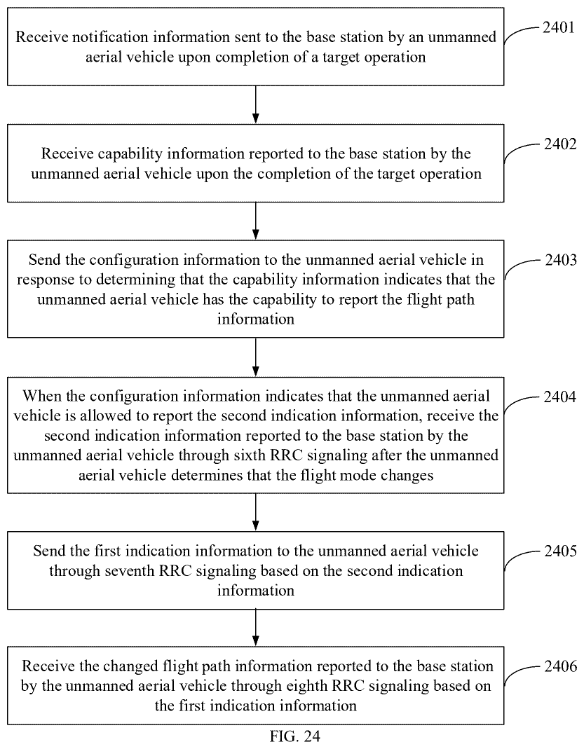

In some embodiments, with reference to FIG. 24, FIG. 24 is a flowchart of an information transmission method according to an embodiment, which can be performed by a base station, and the method may include the following steps.

At step 2401, notification information sent to the base station by an unmanned aerial vehicle upon completion of a target operation is received.

The implementation of step 2401 is similar to the step 1301 or 1401, which is not repeated here.

At step 2402, capability information reported to the base station by the unmanned aerial vehicle upon the completion of the target operation is received.

The implementation of step 2402 is similar to the step 1702 or 1802, which is not repeated here.

At step 2403, in response to determining that the capability information indicates that the unmanned aerial vehicle has the capability to report the flight path information, the configuration information is sent to the unmanned aerial vehicle.

The implementation of step 2403 is similar to the step 1903 or 2003, which is not repeated here.

At step 2404, when the configuration information indicates that the unmanned aerial vehicle is allowed to report the second indication information, the second indication information reported to the base station by the unmanned aerial vehicle through sixth RRC signaling after the unmanned aerial vehicle determines that the flight mode changes is received.

In the embodiment of the present disclosure, if the unmanned aerial vehicle determines that the base station allows the unmanned aerial vehicle to report the second indication information based on the configuration information, and the second indication information indicates that the unmanned aerial vehicle stores the flight path information, then the unmanned aerial vehicle can report the second indication information to the base station through the sixth RRC signaling.

In a possible implementation, the sixth RRC signaling can reuse existing RRC signaling in a protocol or it can be newly defined RRC signaling in the protocol, which is not limited by the present disclosure.

In a possible implementation, the sixth RRC signaling reuses the existing RRC signaling in the protocol, and it may specifically be UEAssistanceInformation signaling.

At step 2405, based on the second indication information, the first indication information is sent to the unmanned aerial vehicle through seventh RRC signaling.

The first indication information instructs the unmanned aerial vehicle to report flight path information.

In the embodiment of the present disclosure, the seventh RRC signaling can reuse existing RRC signaling in a protocol or it can be newly defined RRC signaling in the protocol, which is not limited by the present disclosure.

In a possible implementation, the seventh RRC signaling reuses the existing RRC signaling in the protocol, and it may specifically be UEInformationRequest signaling.

At step 2406, the changed flight path information reported to the base station by the unmanned aerial vehicle through eighth RRC signaling based on the first indication information is received.

In a possible implementation, the eighth RRC signaling can reuse existing RRC signaling in a protocol or it can be newly defined RRC signaling in the protocol, which is not limited by the present disclosure.

In a possible implementation, the eighth RRC signaling reuses the existing RRC signaling in the protocol, and corresponds to the seventh RRC signaling, the eighth RRC signaling may specifically be UEInformationResponse signaling.

In the above embodiment, the base station can send the first indication information to the UAV through the seventh RRC signaling, and the UAV can report the changed flight path information to the base station through the eighth RRC signaling. The purpose of reporting flight path information efficiently when the flight mode changes is realized is simple to realize and high in usability.

Corresponding to the foregoing embodiments of the application function realization methods, the present disclosure further provides embodiments of application function realization apparatuses.

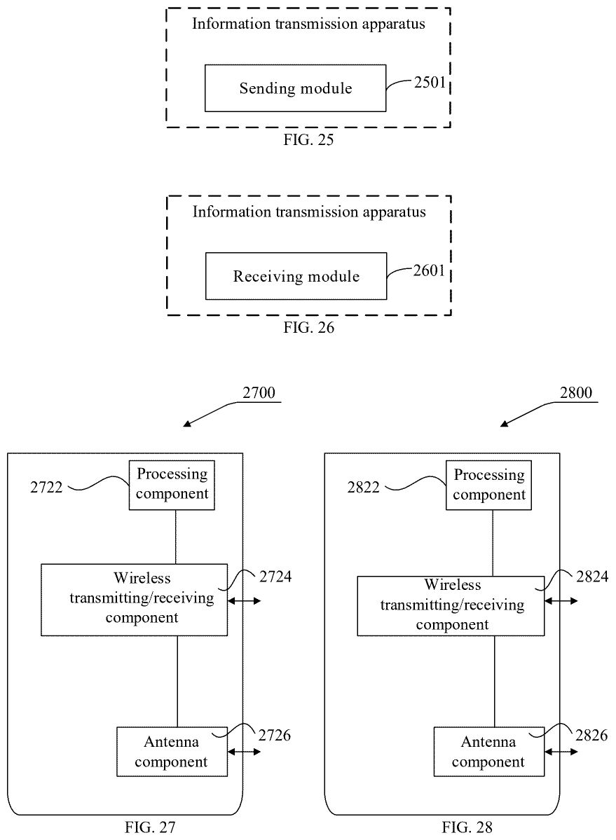

Referring to FIG. 25, FIG. 25 is a block diagram of an information transmission apparatus according to an embodiment of the present disclosure, which is applied to an unmanned aerial vehicle and includes:
a sending module 2501, configured to send notification information to a base station upon completion of a target operation, where the target operation is an operation associated with a radio resource control (RRC) connection between the unmanned aerial vehicle and the base station, and the notification information informs the base station that the unmanned aerial vehicle stores flight path information.

Referring to FIG. 26, FIG. 26 is a block diagram of an information transmission apparatus according to an embodiment of the present disclosure, which is applied to a base station and includes:
a receiving module 2601, configured to receive notification information sent to the base station by an unmanned aerial vehicle upon completion of a target operation, where the target operation is an operation associated with a radio resource control (RRC) connection between the unmanned aerial vehicle and the base station, and the notification information informs the base station that the unmanned aerial vehicle stores flight path information.

For the apparatus embodiment, because it basically corresponds to the method embodiment, it is only necessary to refer to the method embodiment for the relevant part of the description. The apparatus embodiments described above are only schematic, in which the units described above as separate components may or may not be physically separated, and the components displayed as units may or may not be physical units, that is, they may be located in one place or distributed to multiple network units. Some or all of the modules can be selected according to actual needs to achieve the purpose of the solution of the present disclosure. It can be understood and implemented by a person of ordinary skill in the art without creative labor.

Correspondingly, the present disclosure further provides a computer-readable storage medium, where the storage medium stores a computer program for executing any of the information transmission methods described above for the unmanned aerial vehicle side.

Correspondingly, the present disclosure further provides a computer-readable storage medium, where the storage medium stores a computer program for executing any of the information transmission methods described above for the base station side.

Correspondingly, the present disclosure further provides an information transmission apparatus, including:
a processor; and
a memory, configured to store processor-executable instructions;
where the processor is configured to execute any of the information transmission methods described above on the unmanned aerial vehicle side.

As shown in FIG. 27, FIG. 27 is a schematic structural diagram of an information transmission apparatus 2700 according to an embodiment of the present disclosure. The apparatus 2700 may be provided as an unmanned aerial vehicle. Referring to FIG. 27, the apparatus 2700 includes a processing component 2722, a wireless transmitting/receiving component 2724, an antenna component 2726, and a signal processing part unique to a wireless interface, and the processing component 2722 may further include at least one processor.

One of the processors in the processing component 2722 may be configured to perform any of the information transmission methods described above for the unmanned aerial vehicle side.

Correspondingly, the present disclosure further provides an information transmission apparatus, including:
a processor; and
a memory, configured to store processor-executable instructions;
where the processor is configured to execute any of the information transmission methods described above on the base station side.

As shown in FIG. 28, FIG. 28 is a schematic structural diagram of an information transmission apparatus 2800 according to an embodiment of the present disclosure. The apparatus 2800 may be provided as a base station. Referring to FIG. 28, the apparatus 2800 includes a processing component 2822, a wireless transmitting/receiving component 2824, an antenna component 2826, and a signal processing part unique to a wireless interface, and the processing component 2822 may further include at least one processor.

One of the processors in the processing component 2822 may be configured to perform any of the information transmission methods described above for the base station side.

Other embodiments of the present disclosure will easily occur to those skilled in the art after considering the specification and practicing the present disclosure disclosed herein. The present disclosure is intended to cover any variations, uses or adaptations of the present disclosure, and these variations, uses or adaptations follow general principles of the present disclosure and include common sense or common technical means in the technical field that are not disclosed in the present disclosure. The specification and embodiments are to be regarded as exemplary only, and true scope and spirit of the present disclosure are indicated by the following claims.

It should be understood that the present disclosure is not limited to precise structures described above and shown in the accompanying drawings, and various modifications and changes can be made without departing from its scope. The scope of the present disclosure is limited only by the appended claims.

1. A method for information transmission performed by an unmanned aerial vehicle, the method comprising:
sending notification information to a base station upon completion of a target operation, wherein the target operation is an operation associated with a radio resource control (RRC) connection between the unmanned aerial vehicle and the base station, and the notification information informs the base station that the unmanned aerial vehicle stores flight path information.

2. The method according to claim 1, wherein the target operation comprises any one of:
an RRC connection setup operation;
an RRC connection reestablishment operation;
an RRC restart operation; and
an RRC reconfiguration operation.

3. The method according to claim 1, wherein the sending notification information to the base station comprises:
sending the notification information to the base station through first RRC signaling, wherein the first RRC signaling corresponds to the target operation,
wherein the first RRC signaling comprises any one of:
RRC Setup Complete (RRCSetupComplete) signaling;
RRC Reestablishment Complete (RRCReestablishmentComplete) signaling;
RRC Resume Complete (RRCResumeComplete) signaling;
RRC Reconfiguration Complete (RRCReconfigurationComplete) signaling;
RRC Connection Setup Complete (RRCConnectionSetupComplete) signaling;
RRC Connection Reestablishment Complete (RRCConnectionReestablishmentComplete) signaling;
RRC Connection Resume Complete (RRCConnectionResumeComplete) signaling; and
RRC Connection Reconfiguration Complete (RRCConnectionReconfigurationComplete) signaling.

4-5. (canceled)

6. The method according to claim 1, further comprising:
receiving first indication information sent by the base station based on the notification information, wherein the first indication information instructs the unmanned aerial vehicle to report flight path information; and
reporting the flight path information to the base station based on the first indication information.

7. The method according to claim 6, wherein the receiving first indication information sent by the base station based on the notification information comprises:
receiving the first indication information sent by the base station through second RRC signaling based on the notification information;
wherein the reporting the flight path information to the base station comprises:
reporting the flight path information to the base station through third RRC signaling.

8. The method according to claim 7, wherein the second RRC signaling is user equipment information request (UEInformationRequest) signaling, and the third RRC signaling is user equipment information response (UEInformationResponse) signaling.

9. The method according to claim 1, further comprising:
reporting capability information to the base station upon the completion of the target operation, wherein the capability information indicates whether the unmanned aerial vehicle has a capability to report flight path information.

10. The method according to claim 9, wherein the reporting capability information to the base station comprises:
reporting the capability information to the base station through fourth RRC signaling;
wherein the reporting the capability information to the base station through fourth RRC signaling comprises:
reporting the capability information to the base station through a first information element in the fourth RRC signaling;
wherein the fourth RRC signaling is user equipment-evolved universal terrestrial radio access-capability (UE-EUTRA-Capability) signaling, and the first information element is an OtherParameters information element; or the fourth RRC signaling is user equipment-new radio-capability (UE-NR-Capability) signaling, and the first information element is an OtherParameters information element.

11-12. (canceled)

13. The method according to claim 9, further comprising:
receiving configuration information sent by the base station based on the capability information, wherein the configuration information is for configuring the unmanned aerial vehicle to report flight path information.

14. The method according to claim 13, wherein the configuration information is for configuring at least one of:
whether the unmanned aerial vehicle is allowed to report flight path information; or
whether the unmanned aerial vehicle is allowed to report second indication information; wherein the second indication information indicates that the unmanned aerial vehicle stores flight path information;
wherein the method further comprises:
in response to determining that a flight mode of the unmanned aerial vehicle changes, obtaining changed flight path information; and
reporting, based on the configuration information, the changed flight path information to the base station.

15. The method according to claim 13, wherein the receiving configuration information sent by the base station based on the capability information comprises:
receiving the configuration information sent by the base station through fifth RRC signaling based on the capability information;
wherein the receiving the configuration information sent by the base station through fifth RRC signaling based on the capability information comprises:
receiving the configuration information sent by the base station through a second information element in the fifth RRC signaling based on the capability information;
wherein the fifth RRC signaling is RRC Connection Reconfiguration (RRCConnectionReconfiguration) signaling, and the second information element is an other configuration (OtherConfig) information element; or the fifth RRC signaling is RRC Reconfiguration (RRCReconfiguration) signaling, and the second information element is the other configuration (OtherConfig) information element.

16-18. (canceled)

19. The method according to claim 14, wherein the reporting, based on the configuration information, the changed flight path information to the base station comprises:
in response to determining that the configuration information indicates that the unmanned aerial vehicle is allowed to report flight path information, reporting the changed flight path information to the base station through sixth RRC signaling;
or
in response to determining that the configuration information indicates that the unmanned aerial vehicle is allowed to report the second indication information, reporting the second indication information to the base station through sixth RRC signaling;
receiving first indication information sent by the base station based on the second indication information, wherein the first indication information instructs the unmanned aerial vehicle to report flight path information; and
reporting, based on the first indication information, the changed flight path information to the base station.

20. (canceled)

21. The method according to claim 19, wherein the sixth RRC signaling is user equipment assistance information (UEAssistanceInformation) signaling,
wherein the receiving first indication information sent by the base station based on the second indication information comprises:
receiving the first indication information sent by the base station through seventh RRC signaling based on the second indication information;
wherein the reporting the changed flight path information to the base station comprises:
reporting the changed flight path information to the base station through eighth RRC signaling;
wherein the seventh RRC signaling is user equipment information request (UEInformationRequest) signaling, and the eighth RRC signaling is user equipment information response (UEInformationResponse) signaling.

22-23. (canceled)

24. A method for information transmission performed by a base station, the method comprising:
receiving notification information sent to the base station by an unmanned aerial vehicle upon completion of a target operation, wherein the target operation is an operation associated with a radio resource control (RRC) connection between the unmanned aerial vehicle and the base station, and the notification information informs the base station that the unmanned aerial vehicle stores flight path information.

25-28. (canceled)

29. The method according to claim 24, further comprising:
sending, based on the notification information, first indication information to the unmanned aerial vehicle, wherein the first indication information instructs the unmanned aerial vehicle to report flight path information; and
receiving the flight path information reported to the base station by the unmanned aerial vehicle based on the first indication information;
wherein the sending first indication information to the unmanned aerial vehicle comprises:
sending the first indication information to the unmanned aerial vehicle through second RRC signaling;
wherein the receiving the flight path information reported to the base station by the unmanned aerial vehicle based on the first indication information comprises:
receiving the flight path information reported to the base station by the unmanned aerial vehicle through third RRC signaling based on the first indication information;
wherein the second RRC signaling is user equipment information request (UEInformationRequest) signaling, and the third RRC signaling is user equipment information response (UEInformationResponse) signaling.

30-31. (canceled)

32. The method according to claim 24, further comprising:
receiving capability information reported to the base station by the unmanned aerial vehicle upon the completion of the target operation, wherein the capability information indicates whether the unmanned aerial vehicle has a capability to report flight path information.

33. The method according to claim 32, wherein the receiving capability information reported to the base station by the unmanned aerial vehicle upon the completion of the target operation comprises:
receiving the capability information reported to the base station by the unmanned aerial vehicle through fourth RRC signaling upon the completion of the target operation;
wherein the receiving the capability information reported to the base station by the unmanned aerial vehicle through fourth RRC signaling upon the completion of the target operation comprises:
receiving the capability information reported to the base station by the unmanned aerial vehicle through a first information element in the fourth RRC signaling upon the completion of the target operation;
wherein the fourth RRC signaling is user equipment-evolved universal terrestrial radio access-capability (UE-EUTRA-Capability) signaling, and the first information element is an OtherParameters information element; or the fourth RRC signaling is user equipment-new radio-capability (UE-NR-Capability) signaling, and the first information element is an OtherParameters information element.

34-35. (canceled)

36. The method according to claim 32, further comprising:
in response to determining that the capability information indicates that the unmanned aerial vehicle has the capability to report the flight path information, sending configuration information to the unmanned aerial vehicle, wherein the configuration information is for configuring the unmanned aerial vehicle to report flight path information;
wherein the configuration information is for configuring at least one of:
whether the unmanned aerial vehicle is allowed to report flight path information;
whether the unmanned aerial vehicle is allowed to report second indication information; wherein the second indication information indicates that the unmanned aerial vehicle stores flight path information;
wherein the method further comprises:
receiving changed flight path information reported to the base station by the unmanned aerial vehicle based on the configuration information after the unmanned aerial vehicle determines that a flight mode changes.

37-50. (canceled)

51. An information configuration apparatus, comprising:
a memory, configured to store processor-executable instructions; and
one or more processors communicatively coupled to the memory,
wherein the one or more processors are collectively configured to:
send notification information to a base station upon completion of a target operation, wherein the target operation is an operation associated with a radio resource control (RRC) connection between an unmanned aerial vehicle and the base station, and the notification information informs the base station that the unmanned aerial vehicle stores flight path information.

52. An information configuration apparatus, comprising:
a memory, configured to store processor-executable instructions;
one or more processors communicatively coupled to the memory
wherein the instructions when collectively executed by the one or more processors cause the information to act as the base station and perform the method according to claim 24.
